(19) United States
(12) Patent Application Publication
(10) Pub. No.: US 2015/0158271 A1
(43) Pub. Date: Jun. 11, 2015

(54) CROSSLINKABLE RESIN MOLDED BODY, CROSSLINKED RESIN MOLDED BODY, AND LAMINATE

(71) Applicant: ZEON CORPORATION, Tokyo (JP)

(72) Inventors: Manabu Hoshino, Tokyo (JP); Kenji Ohno, Tokyo (JP); Masanori Yoshihara, Tokyo (JP)

(73) Assignee: ZEON CORPORATION, Tokyo (JP)

(21) Appl. No.: 14/406,615

(22) PCT Filed: Jun. 14, 2013
(86) PCT No.: PCT/JP2013/067019

§ 371 Date: Dec. 9, 2014

(30) Foreign Application Priority Data
Jun. 14, 2012 (JP) 2012-135073

(51) Int. Cl. B32B 5/26; C08K 3/22; D06M 15/227; C08K 3/36

(52) U.S. Cl. CPC B32B 5/26; C08K 3/36; C08K 3/22; D06M 15/227; C08K 2003/2227; B32B 2260/023; B32B 2262/101; B32B 2260/046; B32B 2305/72; B32B 2305/77; B32B 2457/08

(57) ABSTRACT

The present invention provides: a crosslinkable resin formed article that is obtained by impregnating an inorganic fibrous support with a polymerizable composition, and subjecting the polymerizable composition to bulk polymerization, the polymerizable composition comprising (A) a cycloolefin monomer, (B) a metathesis polymerization catalyst, (C) a crosslinking agent, (D) an inorganic filler that consists of particles having an average particle size of 0.1 to 1.0 μm, and (E) an inorganic filler that consists of particles having an average particle size of 1.5 to 5.0 μm, the polymerizable composition having a total content of the component (D) and the component (E) of 60 to 80 wt %, and having a weight ratio (component (D):component (E)) of the component (D) to the component (E) of 5:95 to 40:60; a crosslinked resin formed article obtained by crosslinking the crosslinkable resin formed article; and a laminate produced by stacking the crosslinkable resin formed articles.

### TECHNICAL FIELD

The invention relates to a crosslinkable resin formed article that is useful as an intermediate for producing a crosslinked resin formed article that has a high modulus of elasticity, and exhibits excellent heat resistance and excellent flame retardancy, a crosslinked resin formed article obtained by crosslinking the crosslinkable resin formed article, and a laminate produced by stacking these resin formed articles.

### BACKGROUND ART

Along with a reduction in size and an improvement in performance of electronic devices, an increase in density and a reduction in thickness have been desired for a printed circuit board used for electronic devices. A resin formed article and a laminate (hereinafter may be referred to as “laminate and the like”) that exhibit excellent mechanical strength and the like have been desired in order to implement an increase in density and a reduction in thickness of a printed circuit board.

It has bees known that the mechanical strength, the peel strength, and the heat resistance of the laminate and the like may be improved by incorporating an inorganic filler in the laminate and the like.

For example, Patent Document 1 discloses a metal-clad laminated sheet that exhibits improved heat resistance, peel strength, and the like, and is obtained using a resin composition that includes an inorganic filler and a thermosetting resin as essential components, wherein the inorganic filler is aluminum hydroxide having an average particle size of 1.0 to 5.0 μm, a content of particles having a particle size of 0.5 μm or less of 0.2 mass % or less, a BET specific surface area of 1.5 m²/g or less, and a content of coarse particles having a particle size of 45 μm or more of 20 ppm or less.

Patent Document 2 discloses a laminate that exhibits excellent mechanical strength and peel strength, and is obtained using a prepreg produced by a production method that includes impregnating reinforcing fibers with a first resin composition that includes a first crosslinkable resin and a first inorganic filler to form a resin-impregnated reinforcing fiber layer, and forming an outer resin layer on each side of the resin-impregnated reinforcing fiber layer using a second resin composition that includes a second crosslinkable resin and a second inorganic filler, wherein the average particle size of the first inorganic filler is smaller than the average particle size of the second inorganic filler.

The mechanical strength, the peel strength, the heat resistance, and the like of the laminate and the like can be improved by thus incorporating an inorganic filler.

However, a further increase in density and a further reduction in thickness of a printed circuit board have progressed in recent years, and a laminate and the like that have a higher modulus of elasticity, and exhibit excellent heat resistance and excellent flame retardancy have been desired.

### RELATED-ART DOCUMENT

### Patent Document

Patent Document 1: JP-A-2007-146095

Patent Document 2: JP-A-2012-6990

### SUMMARY OF THE INVENTION

### Technical Problem

The invention was conceived in view of the above situation. An object of the invention is to provide a crosslinkable resin formed article that is useful as an intermediate for producing a crosslinked resin formed article that has a high modulus of elasticity, and exhibits excellent heat resistance and excellent flame retardancy, a crosslinked resin formed article obtained by crosslinking the crosslinkable resin formed article, and a laminate produced by stacking these resin formed articles.

A laminate and the like having the above properties may be obtained by increasing the degree of filling with an inorganic filler (i.e., the inorganic filler content per unit volume).

However, when producing a resin formed article or a laminate by impregnating an inorganic fibrous support with the resin composite disclosed in Patent Document 1, the inorganic filler cannot easily enter the spaces formed in the inorganic fibrous support, and it is difficult to increase the degree of filling with the inorganic filler in an area including the inorganic fibrous support.

When producing a laminate using the method disclosed in Patent Document 2, it is difficult to reduce the amount of resin, and increase the degree of filling with the inorganic filler in an area that does not include the inorganic fibrous support.

### Solution to Problem

The inventors of the invention conducted extensive studies in order to achieve the above object. As a result, the inventors found that (i) a polymerizable composition that has a high inorganic filler content while maintaining relatively low viscosity can be obtained by preparing a polymerizable composition that includes (A) a cycloolefin monomer, (B) a metathesis polymerization catalyst, and (C) a crosslinking agent, and further includes (D) an inorganic filler that consists of particles having an average particle size of 0.1 to 1.0 μm, and (E) an inorganic filler that consists of particles having an average particle size of 1.5 to 5.0 μm, in a specific ratio, (ii) a crosslinkable resin formed article in which an area that includes the inorganic fibrous support and an area that does not include the inorganic fibrous support are sufficiently filled with the inorganic filler, can be easily obtained by impregnating the inorganic fibrous support with the polymerizable composition, and subjecting the polymerizable composition to bulk polymerization, and (iii) a crosslinked resin formed article that has a high modulus of elasticity, and exhibits excellent heat resistance and excellent flame retardancy, can be obtained by crosslinking the crosslinkable resin formed article. These finding have led to the completion of the invention.

Several aspects of the invention provide the following crosslinkable resin formed article (see (1) to (4)), crosslinked resin formed article (see (6)), and laminate (see (7)).

(1) A crosslinkable resin formed article that is obtained by impregnating an inorganic fibrous support with a polymerizable composition, and subjecting the polymerizable composition to bulk polymerization,

the polymerizable composition including (A) a cycloolefin monomer, (B) a metathesis polymerization catalyst, (C) a crosslinking agent, (D) an inorganic filler that consists of particles having an average particle size of 0.1 to 1.0 μm, and (E) an inorganic filler that consists of particles having an average particle size of 1.5 to 5.0 μm, the polymerizable composition having a total content of the component (D) and the component (E) of 60 to 80 wt %, and having a weight ratio (component (D):component (E)) of the component (D) to the component (E) of 5:95 to 40:60.

(2) The crosslinkable resin formed article according to (1), the crosslinkable resin formed article including an inner-layer part that includes the inorganic fibrous support, and an outer-layer part that is adjacent to the inner-layer part, and does not include the inorganic fibrous support, wherein only the component (D) is dispersed in the inner-layer part.
(3) The crosslinkable resin formed article according to (1) or (2), wherein the polymerizable composition includes a cycloolefin monomer represented by the following formula (I) and a crosslinkable cycloolefin monomer (that excludes the compound (cycloolefin monomer) represented by the formula (I)) as the component (A).

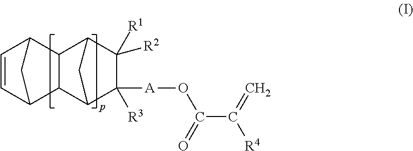

wherein R¹, R², and R³ independently a hydrogen atom or a hydrocarbon group having 1 to 20 carbon atoms, R⁴ is a hydrogen atom or a methyl group, A is a single bond, an alkylene group having 1 to 20 carbon atoms, or a divalent group represented by the following formula (II), and p is 0, 1, or 2,

*—C(═O)—O-A¹- (II)

wherein A¹ is an alkylene group having 1 to 19 carbon atoms, and * is a site that is bonded to the carbon atom that forms the alicyclic structure in the formula (I).

(4) The crosslinkable resin formed article according to any one of (1) to (3), wherein the component (D) is silicon dioxide, and the component (E) is a metal hydroxide.
(5) The crosslinkable resin formed article according to any one of (1) to (4), the crosslinkable resin formed article producing a crosslinked resin formed article having a storage modulus at 260 ° C. of 1.0×10⁹ Pa or more when subjected to a crosslinking reaction.
(6) A crosslinked resin formed article obtained by crosslinking the crosslinkable resin formed article according to any one of (1) to (5).
(7) A laminate produced by stacking the crosslinkable resin formed articles according to any one of (1) to (5), or the crosslinked resin formed articles according to (6).

### ADVANTAGEOUS EFFECTS OF THE INVENTION

Several aspects of the invention thus provide a crosslinkable resin formed article that is useful as an intermediate for producing a crosslinked resin formed article that has a high modulus of elasticity, and exhibits excellent heat resistance and excellent flame retardancy, a crosslinked resin formed article obtained by crosslinking the crosslinkable resin formed article, and a laminate obtained by stacking these resin formed articles.

Since the crosslinked resin formed article obtained by crosslinking the crosslinkable resin formed article, and the laminate produced by stacking these resin formed articles have a high modulus of elasticity, and exhibit excellent heat resistance and excellent flame retardancy, the crosslinked resin formed article and the laminate may suitably be used as a resin formed article and a laminate for producing a printed circuit board.

### BRIEF DESCRIPTION OF DRAWINGS

FIG. 1 is a schematic cross-sectional view illustrating a crosslinkable resin formed article and a crosslinked resin formed article according to exemplary embodiments of the invention.

FIG. 2 shows the SEM images of the observation samples of the laminate 1 obtained in Example 1 (see (C)), the laminate 8 obtained in Comparative Example 2 (see (A)), and the laminate 9 obtained in Comparative Example 3 (see (B)).

FIG. 3 shows the SEM-EDX images of the observation samples of the laminate 1 obtained in Example 1 (see (B)) and the laminate 9 obtained in Comparative Example 3 (see (A)).

### DESCRIPTION OF EMBODIMENTS

A crosslinkable resin formed article, a crosslinked resin formed article, and a laminate according to several embodiments of the invention are described in detail below.

### 1) Crosslinkable Resin Formed Article

A crosslinkable resin formed article according to one embodiment of the invention is obtained by impregnating an inorganic fibrous support with a polymerizable composition, and subjecting the polymerizable composition to bulk polymerization, the polymerizable composition including (A) a cycloolefin monomer (hereinafter may be referred to as “component (A)”), (B) a metathesis polymerization catalyst (hereinafter may be referred to as “component (B)”), (C) a crosslinking agent (hereinafter may be referred to as “component (C)”), (D) an inorganic filler that consists of particles having an average particle size of 0.1 to 1.0 μm (hereinafter may be referred to as “component (D)”), and (E) an inorganic filler that consists of particles having an average particle size of 1.5 to 5.0 μm (hereinafter may be referred to as “component (E)”), the polymerizable composition having a total content of the component (D) and the component (E) of 60 to 80 wt %, and having a weight ratio (component (D):component (E)) of the component (D) to the component (E) of 5:95 to 40:60.

### Polymerizable Composition

The polymerizable composition used in connection with one embodiment of the invention includes the cycloolefin monomer as the component (A).

The term “cycloolefin monomer” used herein refers to a compound that has an alicyclic structure formed by carbon atoms, and includes at least one polymerizable carbon-carbon double bond in the alicyclic structure.

The term “polymerizable carbon-carbon double bond” used herein refers to a carbon-carbon double bond that can be involved in ring-opening polymerization. Ring-opening polymerization may be implemented by ionic polymerization, radical polymerization, metathesis polymerization, or the like. The term “ring-opening polymerization” used herein normally refers to ring-opening metathesis polymerization.

Examples of the alicyclic structure included in the cycloolefin monomer include a monocyclic ring, a polycyclic ring, a fused polycyclic ring, a bridged ring, a combination thereof, and the like. The number of carbon atoms that form the alicyclic structure is not particularly limited, but is normally 4 to 30, preferable 5 to 20, and still more preferable 5 to 15. It is preferable that the alicyclic structure be a polycyclic structure in order to ensure that the resulting crosslinked resin formed article and the resulting laminate exhibit dielectric properties and heat resistance in a well-balanced manner. A norbornene-based monomer is particularly preferable as the cycloolefin monomer having a polycyclic structure. Note that the term “norbornene-based monomer” used herein refers to a cycloolefin monomer that includes a norbornene ring structure in the molecule. Examples of the norbornene-based monomer include norbornenes, dicyclopentadienes, tetracyclododecenes, and the like.

The cycloolefin monomer may be substituted with a substituent at an arbitrary position. Examples of the substituent include hydrocarbon groups having 1 to 30 carbon atoms, such as an alkyl group, an alkenyl group, an alkylidene group, and an aryl group; polar groups such as a carboxyl group and an acid anhydride group; and the like.

The polymerizable composition may include only one type of cycloolefin monomer, or may include two or more types of cycloolefin monomers.

Since the polymerizable composition used in connection with one embodiment of the invention includes the cycloolefin monomer, the content of the inorganic filler (components (D) and (E)) in the polymerizable composition can be increased while maintaining relatively low viscosity. A crosslinkable resin formed article that is useful as an intermediate for producing a crosslinked resin formed article that has a high modulus of elasticity, and exhibits excellent heat resistance and excellent flame retardancy can be obtained by utilizing the polymerizable composition.

A crosslinkable cycloolefin monomer is preferable as the cycloolefin monomer. The term “crosslinkable cycloolefin monomer” used herein refers to a cylcoolefin monomer that includes at least one polymerizable carbon-carbon double bond in the alicyclic structure, and also includes at least one crosslinkable carbon-carbon double bond.

The term “crosslinkable carbon-carbon double bond” used herein refers to a carbon-carbon double bond that is not involved in ring-opening polymerization, but can be involved in a crosslinking reaction. The crosslinking reaction is a reaction that forms a crosslinked (bridged) structure. The crosslinking reaction may be implemented by a condensation reaction, an addition reaction, a radical reaction, a metathesis reaction, or the like. The term “crosslinking reaction” used herein typically refers to a radical crosslinking reaction or a metathesis crosslinking reaction (particularly a radical crosslinking reaction).

The position of the crosslinkable carbon-carbon double bond in the crosslinkable cycloolefin monomer is not particularly limited. The crosslinkable carbon-carbon double bond may be present in the alicyclic structure formed by carbon atoms, or may be present at an arbitrary position (e.g., in the side chain) other than the alicyclic structure. For example, the crosslinkable carbon-carbon double bond may be present in a vinyl group (CH₂═CH—), a vinylidene group (CH₂═C<), a vinylene group (—CH═CH—), a 1-propenylidene group (>C═CH—CH₃), an acryloyloxy group, a methacryloyloxy group, or the like.

It is preferable that the polymerizable composition used in connection with one embodiment of the invention include a compound represented by the formula (I) and a crosslinkable cycloolefin monomer (that excludes the compound represented by the formula (I)) (hereinafter may be referred to as “cycloolefin monomer (α)”) as the component (A). A polymerizable composition having low viscosity can be easily obtained by utilizing these compounds. A crosslinkable resin formed article that has a higher modulus of elasticity, and is useful as an intermediate for producing a crosslinked resin formed article that exhibits more excellent heat resistance and flame retardancy can be easily obtained by utilizing the polymerizable composition that includes these compounds.

R¹ to R³ in the formula (I) are independently a hydrogen atom or a hydrocarbon group having 1 to 20 carbon atoms. The number of carbon atoms of the hydrocarbon group that may be represented by R¹ to R³ is preferably 1 to 10, and more preferably 1 to 5.

Examples of the hydrocarbon group having 1 to 20 carbon atoms that may be represented by R¹ R³ include alkyl groups having 1 to 20 carbon atoms, such as a methyl group, an ethyl group, and a propyl group; alkenyl groups having 2 to 20 carbon atoms, such as a vinyl group, a propenyl group, and a crotyl group; alkynyl groups having 2 to 20 carbon atoms, such as an ethynyl group, a propargyl group, and a 3-butynyl group; aryl groups having 6 to 20 carbon atoms, such as a phenyl group and a 2-naphthyl group; cycloalkyl groups having 3 to 20 carbon atoms, such as a cyclopropyl group, a cyclopentyl group, and a cyclohexyl group; and the like.

It is preferable the R¹ to R³ be independently a hydrogen atom or an alkyl group having 1 to 20 carbon atoms in order to ensure excellent polymerization reactivity. It is more preferable that all of R¹ to R³ be a hydrogen atom.

R⁴ is a hydrogen atom or a methyl group, and preferably a methyl group.

A is a single bond, an alkylene group having 1 to 20 carbon atoms, or a divalent group represented by the following formula (II).

*—C(═O)—O-A¹- (II)

When A is a single bond, the group represented by —O—C(═O)—C(R⁴)═CH₂ in the formula (I) is bonded directly to the carbon atom that forms the alicyclic structure.

The number of carbon atoms of the alkylene group having 1 to 20 carbon atoms that may be represented by A is preferably 1 to 10, and more preferably 1 to 5.

Examples of the alkylene group having 1 to 20 carbon atoms that may be represented by A include a methylene group, an ethylene group, a propylene group, a trimethylene group, and the like.

* and A¹ in the formula (II) are the same as defined above.

The number of carbon atoms of the alkylene group having 1 to 19 carbon atoms represented by A¹ is preferable 1 to 9, and more preferably 1 to 4. Examples of the alkylene group having 1 to 19 carbon atoms represented by A¹ include a methylene group, an ethylene group, a propylene group, a trimethylene group, and the like.

p is 0, 1, or 2, and preferably 0 or 1.

Examples of the compound in which p is 0 include 5-norbornen-2-yl acrylate, 5-norbornen-2-yl methacrylate, (5-norbornen-2-yl)methyl acrylate, (5-norbornen-2-yl)methyl methacrylate, 1-(5-norbornen-2-yl)ethyl acrylate, 2-(5-norbornen-2-yl)ethyl acrylate, 1-(5-norbornen-2-yl)ethyl methacrylate, 2-(5-norbornen-2-yl)ethyl methacrylate, 1-(5-norbornen-2-yl)propyl acrylate, 2-(5-norbornen-2-yl)propyl acrylate, 3-(5-norbornen-2-yl)propyl acrylate, 1-(5-norbornen-2-l)propyl methacrylate, 2-(5-norbornen-2-yl)propyl methacrylate, 3-(5-norbornen-2-yl)propyl methacrylate, n-4-(5-norbornen-2-yl)butyl acrylate, n-4-(5-norbornen-2-yl)butyl methacrylate, (5-norbornen-2-yl)hexyl acrylate, (5-norbornen-2-yl)hexyl methacrylate, (5-norbornen-2-yl)octyl acrylate, (5-norbornen-2-yl)octyl methacrylate, (5-norbornen-2-yl)decyl acrylate, (5-norbornen-2-yl)decyl methacrylate, (acryloyloxy)methyl 5-norbornene-2-carboxylate, (methacryloyloxy)methyl 5-norbornene-2-carboxylate, 2-(acryloyloxy)ethyl 5-norbornene-2-carboxylate, 2-(methacryloyloxy)ethyl 5-norbornene-2-carboxylate, and the like.

Examples of the compound in which p is 1 include tetracyclo[6.2.1.1^{3,6}.0^{2,7]dodec-}9-en-4-yl acrylate, tetracyclo[6.2.1.1^{3,6}.0^{2,7}]dodec-9-en-4-yl methacrylate, (tetracyclo[6.2.1.1^{3,6}.0^{2,7}]dodec-9-en-4-yl)methyl acrylate, (tetracyclo[6.2.1.1^{3,6}.0^{2,7}]dodec-9-en-4-yl)methyl methacrylate, 1-(tetracyclo[6.2.1.1^{3,6}.0^{2,7}]dodec-9-en-4-yl)ethyl acrylate, 2-(tetracyclo[6.2.1.1^{3,6}.0^{2,7}]dodec-9-en-4-yl)ethyl acrylate, 1-(tetracyclo[6.2.1.1^{3,6}.0^{2,7}]dodec-9-en-4-yl)ethyl methacrylate, 2-(tetracyclo[6.2.1.1^{3,6}.0^{2,7}]dodec-9-en-4-yl)ethyl methacrylate, 1-(tetracyclo[6.2.1.1^{3,6}.0^{2,7}]dodec-9-en-4-yl)propyl acrylate, 2-(tetracyclo[6.2.1.1^{3,6}.0^{2,7}]dodec-9-en-4-yl)propyl acrylate, 3-(tetracyclo[6.2.1.1^{3,6}.0^{2,7}]dodec-9-en-4-yl)propyl acrylate, 1-(tetracyclo[6.2.1.1^{3,6}.0^{2,7}]dodec-9-en-4-yl)propyl methacrylate, 21-(tetracyclo[6.2.1.1^{3,6}.0^{2,7}]dodec-9-en-4-yl)propyl methacrylate, 3-(tetracyclo[6.2.1.1^{3,6}.0^{2,7}]dodec-9-en-4-yl)propyl methacrylate, 1-(tetracyclo[6.2.1.1^{3,6}.0^{2,7}]dodec-9-en-4-yl)butyl acrylate, 2-(tetracyclo[6.2.1.1^{3,6}.0^{2,7}]dodec-9-en-4-yl)butyl acrylate, 3-(tetracyclo[6.2.1.1^{3,6}.0^{2,7}]dodec-9-en-4-yl)butyl acrylate, 4-(tetracyclo[6.2.1.1^{3,6}.0^{2,7}]dodec-9-en-4-yl)butyl acrylate, 1-(tetracyclo[6.2.1.1^{3,6}.0^{2,7}]dodec-9-en-4-yl)butyl methacrylate, 2-(tetracyclo[6.2.1.1^{3,6}.0^{2,7}]dodec-9-en-4-yl)butyl methacrylate, 3-(tetracyclo[6.2.1.1^{3,6}.0^{2,7}]dodec-9-en-4-yl)butyl methacrylate, 4-(tetracyclo[6.2.1.1^{3,6}.0^{2,7}]dodec-9-en-4-yl)butyl methacrylate, (tetracyclo[6.2.1.1^{3,6}.0^{2,7}]dodec-9-en-4-yl)hexyl acrylate, (tetracyclo[6.2.1.1^{3,6}.0^{2,7}]dodec-9-en-4-yl)hexyl methacrylate, (tetracyclo[6.2.1.1^{3,6}.0^{2,7}]dodec-9-en-4-yl)octyl acrylate, (tetracyclo[6.2.1.1^{3,6}.0^{2,7}]dodec-9-en-4-yl)octyl methacrylate, (tetracyclo[6.2.1.1^{3,6}.0^{2,7}]dodec-9-en-4-yl)decyl acrylate, (tetracyclo[6.2.1.1^{3,6}.0^{2,7}]dodec-9-en-4-yl)decyl methacrylate, (acryloyloxy)methyl tetracyclo[6.2.1.1^{3,6}.0^{2,7}]dodec-9-ene-4-carboxylate, (methacryloyloxy)methyl tetracyclo[6.2.1.1^{3,6}.0^{2,7}]dodec-9-ene-4-carboxylate, 2-(acryloyloxy)ethyl tetracyclo[6.2.1.1^{3,6}.0^{2,7}]dodec-9-ene-4-carboxylate, 2-(methacryloyloxy)ethyl tetracyclo[6.2.1.1^{3,6}.0^{2,7}]dodec-9-ene-4-carboxylate, and the like.

These cycloolefin monomer represented by the formula (I) may be used either alone or in combination.

It is preferable that the cycloolefin monomer (α) include a crosslinkable carbon-carbon double bond in the side chain in order to ensure excellent radical crosslinking reactivity. It is more preferable that the cycloolefin monomer (α) include a vinyl group, a vinylidene group, or a 1-propenylidene group.

Examples of the cycloolefin monomer (α) include a compound represented by the following formula (III) and a compound represented by the following formula (IV).

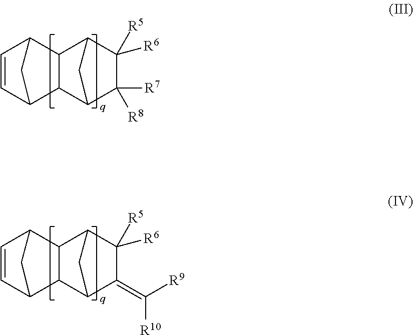

wherein R⁵, R⁶, R⁷, R⁸, R⁹ , and R¹⁰ are independently a hydrogen atom or a hydrocarbon group having 1 to 20 carbon atoms, provided that at least one of R⁵ to R⁸ is the hydrocarbon group.

The number of carbon atoms of the hydrocarbon group that may be represented by R⁵ to R¹⁰ is preferably 1 to 10, and more preferably 1 to 5.

Examples of the hydrocarbon group having 1 to 20 carbon atoms that may be represented by R⁵ to R¹⁰ include those mentioned above in connection with R¹ to R⁵ in the formula (I).

R⁵ or R⁶ and R⁷ or R⁸ are optimally bonded to each other to form a cyclic structure.

The hydrocarbon group that may be repressed by R⁵ to R⁸, or the cyclic structure that may be formed by R⁵ or R⁶ and R⁷ or R⁸ that are bonded to each other, includes an aliphatic carbon-carbon double bond. The aliphatic carbon-carbon double bond is a crosslinkable carbon-carbon double bond.

q is 0, 1, or 2, and preferably 0 or 1.

The cycloolefin monomer (α) is preferably the compound represented by the formula (IV).

Specific examples of the cycloolefin monomer (α) include monocyclic cycloolefin monomers such as 3-vinylcyclohexene, 4-vinylcyclohexene, 1,3-cyclopentadiene, 1,3-cyclohexadiene, 1,4-cyclohexadiene, 5-ethyl-1,3-cyclohexadiene, 1,3-cycloheptadiene, and 1,3-cyclooctadiene; bicyclic cycloolefin monomers such as 5-methylidene-2-norbornene, 5-ethylidene-2-norbornene, 5-n-propylidene-2-norbornene, 5-isopropylidene-2norbornene,-5-vinyl-2-norbornene, 5-allyl-2-norbornene, 5,6-diethylidene-2-norbornene, and 2,5-norbornadiene; tricyclic cycloolefin monomer such as dicyclopentadiene;

tetracyclic cycloolefin monomers having a tetracyclododecene structure, such as 9-methylidynetetracyclo[6.2.1.1^{3,6}.0^{2,7}]dodec-4-ene, 9-methylidyne-10-methyltetracyclo[6.2.1.1^{3,6}.0^{2,7}]dodec-4-ene, 9-methylidyne-10-ethyltetracyclo[6.2.1.1^{3,6}.0^{2,7}]dodec-4-ene, 9-methylidyne-10-isopropyltetracyclo[6.2.1.1^{3,6}.0^{2,7}]dodec-4-ene, 9-methylidyne-10-butyltetracyclo[6.2.1.1^{3,6}.0^{2,7}]dodec-4-ene, 9-ethylidenetetracyclo[6.2.1.1^{3,6}.0^{2,7}]dodec-4-ene, 9-ethylidene-10-methyltetracyclo[6.2.1.1^{3,6}.0^{2,7}]dodec-4-ene, 9-ethylidene-10-ethyltetracyclo[6.2.1.1^{3,6}.0^{2,7}]dodec-4-ene, 9-ethylidene-10-isopropyltetracyclo[6.2.1.1^{3,6}.0^{2,7}]dodec-4-ene, 9-ethylidene-10-butyltetracyclo[6.2.1.1^{3,6}.0^{2,7}]dodec-4-ene, 9-n-propylidenetetracyclo[6.2.1.1^{3,6}.0^{2,7}]dodec-4-ene, 9-n-propylidene-10-methyltetracyclo[6.2.1.1^{3,6}.0^{2,7}]dodec-4-ene, 9-n-propylidene-10-ethyltetracyclo[6.2.1.1^{3,6}.0^{2,7}]dodec-4-ene, 9-n-propylidene-10-isopropyltetracyclo[6.2.1.1^{3,6}.0^{2,7}]dodec-4-ene, 9-n-propylidene-10-butyltetracyclo[6.2.1.1^{3,6}.0^{2,7}]dodec-4-ene, 9-isopropylidenetetracyclo[6.2.1.1^{3,6}.0^{2,7}]dodec-4-ene, 9-isopropylidene-10-methyltetracyclo[6.2.1.1^{3,6}.0^{2,7}]dodec-4-ene, 9-isopropylidene-10-ethyltetracyclo[6.2.1.1^{3,6}.0^{2,7}]dodec-4-ene, 9-isopropylidene-10-isopropyltetracyclo[6.2.1.1^{3,6}.0^{2,7}]dodec-4-ene, 9-isopropylidene-10-butyltetracyclo[6.2.1.1^{3,6}.0^{2,7}]dodec-4-ene, 9-vinyltetracyclo[6.2.1.1^{3,6}.0^{2,7}]dodec-4-ene, and 9-propenyltetracyclo[6.2.1.1^{3,6}.0^{2,7}]dodec-4-ene; and the like.

These cycloolefin monomer (α) may be used either alone or in combination.

When using the cycloolefin monomer represented by the formula (I) and the cycloolefin monomer (α) in combination, the weight ratio (cycloolefin monomer represented by the formula (I): cycloolefin monomer (α)) of the cycloolefin monomer represented by the formula (I) to the cycloolefin monomer (α) is preferably 10:90 to 60:40, more preferably 15:85 to 55:45, and still more preferably 20:80 to 50:50.

When using the cycloolefin monomer represented by the formula (I) and the cycloolefin monomer (α) in combination, the cycloolefin monomer represented by the formula (I) and the cycloolefin monomer (α) may be used in combination with a non-crosslinkable cycloolefin monomer (hereinafter may be referred to as “cycloolefin monomer (β)”).

Specific examples of the cycloolefin monomer (β) include monocyclic cycloolefin monomers such as cyclopentene, 3-methylcyclopentene, 4-methylcyclopentene, 3,4-dimethylcyclopentene, 3,5-dimethylcyclopentene, 3-chlorocyclopentene, cyclohexene, 3-methylcyclohexene, 4-methylcyclohexene, 3,4-dimethylcyclohexene, 3-chlorocyclohexene, and cycloheptene;

bicyclic cycloolefin monomer such a norbornene, 1-methyl-2-norbornene, 5-methyl-2-norbornene, 7-methyl-2-norbornene, 5-ethyl-2-norbornene, 5-propyl-2-norbornene, 5-phenyl-2-norbornene, 5,6-dimethyl-2-norbornene, 5,5,6-trimethyl-2-norbornene, 5-chloro-2-norbornene, 5,5-dichloro-2-norbornene, 5-fluoro-2norbornene, 5,5,6-trifluoro-6-trifluoromethyl-2-norbornene, 5-chloromethyl-2-norbornene, 5-methoxy-2-norbornene, 5,6-dicarboxyl-2-norbornene anyhydride, 5-dimethylamino-2-norbornene, and 5-cyano-2-norbornene; tricyclic cycloolefin monomers such as 1,2-dihydrodicyclopentadiene and 5,6-dihydrodicyclopentadiene;

tetracyclic cycloolefin monomers having a tetracyclododecene structure, such as 1,4,5,8-dimethano-2,2,3,4a,5,8,8a-octahydronaphthalene (TCD), 2-methyl-1,4,5,8-dimethano-1,2,3,4,4a,5,8,8a-octahydronaphthalene, 2-ethyl-1,4,5,8-dimethano-1,2,3,4,4a,5,8,8a-octahydronaphthalene, 2,3-dimethyl-1,4,5,8-dimethano-1,2,3,4,4a,5,8,8a-octahydronaphthalene, 2-hexyl-1,4,5,8-dimethano-1,2,3,4,4a,5,8,8a-octahydronaphthalene, 2-ethylidene-1,4,5,8-dimethano-1,2,3,4,4a,5,8,8a-octahydronaphthalene, 2-fluoro-1,4,5,8-dimethano-1,2,3,4,4a,5,8,8a-octahydronaphthalene, 1,5-dimethyl-1,4,5,8-dimethano-1,2,3,4,4a,5,8,8a-octahydronaphthalene, 2-cyclohexyl-1,4,5,8-dimethano-1,2,3,4,4a,5,8,8a-octahydronaphthalene, 2,3-dichloro-1,4,5,8-dimethano-1,2,3,4,4a,5,8,8a-octahydronaphthalene, and 2-isobutyl-1,4,5,8-dimethano-1,2,3,4,4a,5,8,8a-octahydronaphthalene; and the like.

The cycloolefin monomer (β) is normally used in an amount of 30 parts by weight or less, and preferably 0.5 to 20 parts by weight, based on 100 parts by weight of the cycloolefin monomer represented by the formula (I) and the cycloolefin monomer (α) in total.

The polymerizable composition used in connection with one embodiment of the invention includes the metathesis polymerization catalyst as the component (B).

Examples of the metathesis polymerization catalyst include a transition metal complex in which a plurality of ions, atoms, polyatomic ions, compounds, and the like are bonded to a transition metal atom (center atom). Examples of the transition metal atom include atoms that belong to Group 5, 6, or 8 in the long-form periodic table (hereinafter the same). Examples of the atoms that belong to Group 5 include tantalum. Examples of the atoms that belong to Group 6 include molybdenum and tungsten. Examples of the atoms that belong to Group 8 include ruthenium and osmium. It is preferable to use ruthenium or osmium that belongs to Group 8 as the transition metal atom.

Specifically, it is preferable that the metathesis polymerization catalyst used in connection with one embodiment of the invention be a complex that includes ruthenium or osmium as the center atom, and more preferable a complex that includes ruthenium as the center atom.

A ruthenium carbene complex in which a carbene compound is coordinated to ruthenium is preferable as the complex that includes ruthenium as the center atom. The term “carbene compound” is a generic name for compounds that include a free methylene group, and refers to a compound that includes a divalent carbon atom (carbene carbon) that does not have a charge represented by “>C:”. The ruthenium carbene complex exhibits excellent catalytic activity during bulk polymerization. Therefore, when the polymerizable composition is subjected to bulk polymerization to produce a crosslinkable resin formed article, the resulting formed article rarely emits an odor due to unreacted monomers, and a good formed article can be obtained with high productivity. Since the ruthenium carbene complex is relatively stable with respect to oxygen and moisture in the air, and is not easily inactivated, the ruthenium carbene complex can be used in the air.

Specific examples of the ruthenium carbene complex include a complex represented by the following formula (V) and a complex represented by the following formula (VI).

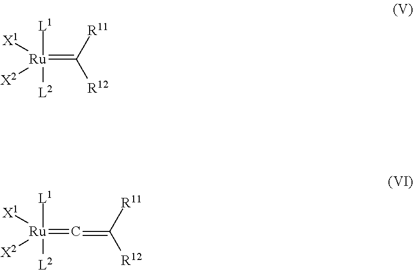

wherein R¹¹ and R¹² are independently a hydrogen atom, a halogen atom, or a cyclic or linear hydrocarbon group having 1 to 20 carbon atoms that optionally includes a halogen atom, an oxygen atom, a nitrogen atom, a sulfur atom, a phosphorus atom, or a silicon atom, X¹ and X² are independently an arbitrary anionic ligand, and L¹ and L² are independently a hetero atom-containing carbene compound or a neutral electron-donor compound other than the hetero atom-containing carbene compound, provided that R¹¹ and R¹² are optionally bonded to each other to form an aliphatic ring or an aromatic ring that optionally includes a hetero atom, and R¹¹, R¹², X¹, X², L¹, and L² are optionally bonded in an arbitrary combination to form a multidentate chelated ligand.

The term “hetero atom” used herein refers to the atoms that belong to Group 15 or 16 in the periodic table. Specific examples of the hetero atom include a nitrogen atom (N), an oxygen atom (O), a phosphorus atom (P), a sulfur atom (S), and arsenic atom (As), a selenium atom (Se), and the like. Among these, N, O, P, S, and the like are preferable, and N is particularly preferable, since a stable carbene compound can be obtained.

It is preferable that the ruthenium carbene complex include at least one carbene compound having a heterocyclic structure (hetero atom-containing carbene compound) as the ligand, since the mechanical strength and the impact resistance of the resulting crosslinked resin formed article and the resulting laminate are highly balanced. An imidazoline ring structure or an imidazolidine cyclic structure is preferable as the heterocyclic structure.

Examples of the carbene compound having a heterocyclic structure include a compound represented by the following formula (VII) and a compound represent by the following formula (VIII).

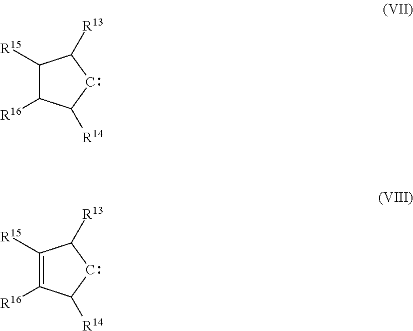

wherein R¹³ to R¹⁶ are independently a hydrogen atom, a halogen atom, or a cyclic or linear hydrocarbon group having 1 to 20 carbon atoms that optionally includes a halogen atom, an oxygen atom, a nitrogen atom, a sulfur atom, a phosphorus atom, or a silicon atom, provided that R¹³ to R¹⁶ are optionally bonded in any arbitrary combination to form a ring.

Examples of the compound represented by the formula (VII) and the compound represented by the formula (VIII) include 1,3-dimesitylimidazolidin-2-ylidene, 1,3-di(1-adamantyl)imidazolidin-2-ylidene, 1,3-dicyclohexylimidazolidin-2-ylidene, 1,3-dimesityloctahdrobenzimidazol-2-ylidene, 1,3-diisopropyl-4-imidazolin-2-ylidene, 1,3-di(1-phenylethyl)-4-imidazolin-2-ylidene, 1,3-dimesityl-2,3-dihydrobenzimidazol-2-ylidene, and the like.

A hetero atom-containing carbene compound such as 1,3,4-triphenyl-2,3,4,5-tetrahydro-1H-1,2,4-triazol-5-ylidene, 1,3-dicyclohexylhexahydropyrimidin-2-ylidene, N,N,N′,N′-tetraisopropylformamidinylidene, 1,3,4-triphenyl-4,5-dihydro-1H-1,2,4-triazol-5-ylidene, or 3-(2,6-diisopropylphenyl)-2,3-dihydrothiazol-2-ylidene may also be used instead of the compound represented by the formula (VII) and the compound represented by the formula (VIII).

The anionic ligands X¹ and X² in the formulas (V) and (VI) are a ligand that is negatively charged when separated from the center atom. Examples of the anionic ligands X¹ and X² include a halogen atom (e.g., fluorine atom (F), chlorine atom (Cl), bromine atom (Br), and iodine atom (I)), a diketonate group, a substituted cyclopentadienyl group, and alkoxy group, an aryloxy group, a carboxyl group, and the like. Among these, a halogen atom is preferable, and a chlorine atom is more preferable.

The neutral electron-donor compound is not particularly limited as long as the neutral electron-donor compound is neutrally charged when separated from the center metal. Specific examples of the neutral electron-donor compound include carbonyls, amines, pyridines, ethers, nitrites, esters, phosphines, thioethers, aromatic compounds, olefins, isocyanides, thiocyanates, and the like. Among these, phosphines, ethers, and pyridines are preferable, and trialkylphosphines are more preferable.

Examples of the ruthenium carbene complex represented by the formula (V) include ruthenium carbene complexes including one hetero atom-containing carbene compound and one neutral electron donor compound, such as benzylidene(1,3-dimesitylimidazolidin-2-ylidene)(tricyclohexylphosphine)ruthenium dichloride, benzylidene(1,3-dimesityl-4,5-dibromo-4-imidazolin-2-ylidene) (tricyclohexylphosphine)ruthenium dichloride, (1,3-dimesityl-4-imidazolin-2-ylidene)(3-phenyl-1H-inden-1-ylidene) (tricyclohexylphosphine)ruthenium dichloride, (1,3-dimesitylimidazolidin-2-ylidene)(3-methyl-2-buten-1-ylidene) (tricyclopentylphosphine)ruthenium dichloride, benzylidene(1,3-dimesityl-octahydrobenzimidazol-2-ylidene) (tricyclohexylphosphine)ruthenium dichloride, benzylidene[1,3,-di(1-phenylethyl)-4-imidazolin-2-ylidene](tricyclohexylphosphine) ruthenium dichloride, benzylidene(1,3-dimesityl-2,3-dihydrobenzimidazol-2-ylidene) (tricyclohexylphosphine)ruthenium dichloride, benzylidene(tricyclohexylphosphine)(1,3,4-triphenyl-2,3,4,5-tetrahydro-1H-1,2,4-triazol-t-ylidene)ruthenium dichloride, (1,3-diisopropylhexahydropyrimidin-2-ylidene)(ethoxymethylene) (tricyclohexylphosphine)ruthenium dichloride, benzylidene(1,3-dimesitylimidazolidin-2-ylidene)pyridineruthenium dichloride, (1,3-dimesitylimidazolidin-2-ylidene)2-phenylethylidene) (tricyclohexylphosphine)ruthenium dichloride, (1,3-dimesityl-4-imidazolin-2-ylidene)(2-phenylethylidene) (tricylcohexylphosphine)ruthenium dichloride, (1,3-dimesityl-4,5-dibromo-4-imidazolin-2-ylidene)[(phenylthio)methylene](tricyclohexylphosphine)ruthenium dichloride, and (1,3-dimesityl-4-,5-dibromo-4-imidazolin-2-ylidene)(2-pyrrolidon-1-ylmethylene) (tricyclohexylphsophine)ruthenium dichloride;

ruthenium carbene complexes including two neutral electron donor compounds, such as benzylidenebis(tricyclohexylphosphine)ruthenium dichloride and (3-methyl-2-buten-1-ylidene)bis(tricyclopentylphosphine)ruthenum dichloride;

ruthenium carbene complexes including two hetero atom-containing carbene compounds, such as benzylidenebis(1,3-dicyclohexylimidazolydin-2-ylidene)ruthenium dichloride and benzylidenebis(1,3-disopropyl-4-imidazolin-2-ylidene)ruthenium dichloride; and the like.

Examples of the ruthenium carbene complex represented by the formula (VI) include (1,3-dimesitylimidazolydin-2-ylidene)(phenylvinylidene) (tricyclohexylphosphine)ruthenium dichloride, (t-butylvinylidene)(1,3-diisopropyl-4-imidazolin-2-ylidene) (tricyclopentylphosphine)ruthenium dichloride, bis-(1,3-dicyclohexyl-4-imidazolin-2-ylidene)phenylvinylideneruthenium dichloride, and the like.

Among these, a ruthenium carbene complex that is represented by the formula (V), and includes one compound represented by the formula (VII) as the ligand is most preferable.

These ruthenium carbene complexes can be produced using the method described in Org. Lett., 1999, Vol. 1, p. 953, or Tetrahedron. Lett., 1999, Vol. 40, p. 2247, for example.

These metathesis polymerization catalysts may be used either alone or in combination.

The metathesis polymerization catalyst is normally used so that the molar ratio of the metal atoms included in the metathesis polymerization catalyst to the cycloolefin monomer (metal atoms included in metathesis polymerization catalyst:cycloolefin monomer) is 1:2000 to 1:2,000,000, preferable 1:5000 to 1:1,000,000, and more preferable 1:10,000 to 1:500,000.

The metathesis polymerization catalyst may optionally be dissolved or suspended in a small amount of an inert solvent. Examples of the inert solvent include linear aliphatic hydrocarbons such as n-pentane, n-hexane, n-heptane, liquid paraffin, and mineral spirit; alicyclic hydrocarbons such as cyclopentane, cyclohexane, methylcyclohexane, dimethylcyclohexane, trimethylcyclohexane, ethylcyclohexane, diethylcyclohexane, decahydronaphthalene, dicycloheptane, tricyclodecane, hexahydroindene, and cyclooctane; aromatic hydrocarbons such as benzene, toluene, and xylene; hydrocarbons that include an alicyclic ring and an aromatic ring, such as indene and tetrahydronaphthalene; nitrogen-containing hydrocarbons such as nitromethane, nitrobenzene, and acetonitrile; oxygen-containing hydrocarbons such as diethyl ether and tetrahydrofuran; and the like. Among these, linear aliphatic hydrocarbons, alicyclic hydrocarbons, aromatic hydrocarbons, and hydrocarbons that include an alicyclic ring and an aromatic ring are preferable.

The polymerizable composition used in connection with one embodiment of the invention includes the crosslinking agent as the component (C).

The crosslinking agent is a compound that can induce a crosslinkable resin produced by polymerizing the polymerizable composition to undergo a crosslinking reaction. Therefore, a resin formed article obtained by subjecting the polymerizable composition to bulk polymerization is a resin formed article that can be post-crosslinked (i.e., crosslinkable resin formed article). The expression “can be post-crosslinked” used herein means that a crosslinked resin formed article can be obtained by crosslinking the resin formed article by heating.

The crosslinking agent is not particularly limited, A radical generator is normally preferable used as the crosslinking agent. Examples of the radical generator include an organic peroxide, a diazo compound, a nonpolar radical generator, and the like. Among these, an organic peroxide and a nonpolar radical generator are preferable.

Examples or the organic peroxide include hydroperoxides such as t-butyl hydroperoxide, p-menthane hydroperoxide, and cumene hydroperoxide; dialkyl peroxides such as dicumyl peroxide, t-butylcumyl peroxide, αα′-bis(t-butylperoxy-m-isopropyl)benzne, di-t-butyl peroxide, 2,5-dimethyl-2,5-di(t-butylperoxy)-3-hexin, and 2,5-dimethyl-2,5-di(t-butylperoxy)hexane; diacyl peroxides such as dipropionyl peroxide and benzoyl peroxide; peroxy ketals such as 2,2-di(t-butylperoxy)butane, 1,1-di(t-hexylperoxy)cycloheane, 1,1-di(t-butylperoxy-2-methylcyclohexane, and 1,1-di(t-butylperoxy)cyclohexane; peroxy esters such as t-butyl peroxyacetate and t-butyl peroxybenzoate; peroxycarbonates such as t-butyl peroxyisopropylcarbonate and diisopropyl peroxydicaronate; alkylsilyl peroxides such as t-butyltrimethylsiyl peroxide; cyclic peroxides such as 3,3,5,7,7-pentamethyl-1,2,4-trioxepane, 3,6,9-triethyl-3,6,9-trimethyl-1,4,7-triperoxonane, and 3,6-diethyl-3,6-dimethyl-1,2,4,5-tetroxane; and the like. Among these, dialkyl peroxides, peroxy ketals, and cyclic peroxides are preferable since the polymerization reaction is not hindered (or hindered to only a small extent).

Examples of the diazo compound include 4,4′-bisazidobenzal(4-methyl)cyclohexanone, 2,6-bis(4′-azidobenzal)cyclohexanone, and the like.

Examples of the nonpolar radical generator include 2,3-dimethyl-2,3-diphenylbutane, 3,4-dimethyl-3,4-diphenylhexane, 1,1,2-triphenylethane, 1,1,1-triphenyl-2-phenylethane, and the like.

When using the radical generator as the crosslinking agent, the one-minute half-life temperature of the radical generator is appropriately selected taking account of the curing conditions (i.e., the crosslinking conditions for the crosslinkable resin formed article), but is normally 100 to 300° C., preferable 150 to 250° C., and more preferable 160 to 230° C. When the on-minute half-life temperature of the radical generator is 100° C. or more, it is possible to easily obtain a crosslinkable resin that exhibits excellent thermal melting properties. When the one-minute half-life temperature of the radical generator is 300° C. or less, the crosslinking reaction can be effected at a moderate temperature. The term “one-minute half-life temperature” used herein refers to a temperature at which half of the radical generator is decomposed within 1 minute.

These crosslinking agent may be used either alone or in combination.

The crosslinking agent is normally used in an amount of 0.01 to 10 parts by weight, preferable 0.1 to 10 parts by weight, and more preferable 0.5 to 5 parts by weight, based on 100 parts by weight of the component (A).

The polymerizable composition used in connection with one embodiment of the invention includes the inorganic filler that consists of particles having an average particle size of 0.1 to 1.0 μm, and preferable 0.2 to 0.8 μm (hereinafter may be referred to as “inorganic filler (D)”) as the component (D).

Since the inorganic filler (D) has a small average particle size, the inorganic filler (D) can easily enter the spaced formed in the inorganic fibrous support when the inorganic fibrous support is impregnated with the polymerizable composition. Therefore, it is possible to obtain a crosslinkable resin formed article in which the inner-layer part is sufficiently filled with the inorganic filler by utilizing the inorganic filler (D). The average particle size of the inorganic filler (D) refers to the volume average particle size D50 measured using a laser diffraction/light scattering grain size distribution measurement analyzer. This also applies to the average particle size of the inorganic filler (E).

The term “outer-layer part” used herein in connection with the crosslinkable resin formed article according to one embodiment of the invention refers to an area in the thickness direction that extends from the surface of the resin to the boundary between the resin and the inorganic fibrous support, and the term “inner-layer part” used herein in connection with the crosslinkable resin formed article according to one embodiment of the invention refers to an area in the thickness direction that is situated between the boundaries. The outer-layer part does not include the inorganic fibrous support, and the inner-layer part includes the inorganic fibrous support. When the inorganic fibrous support is exposed on the surface of the resin formed article, the outer-layer part is substantially not present on the surface of the resin formed article, and the surface of the resin formed article is considered to be the boundary for convenience.

Examples of the inorganic filler (D) include metal hydroxide-based fillers such as magnesium hydroxide, calcium hydroxide, and aluminum hydroxide; metal oxide-based fillers such as magnesium oxide, titanium dioxide, zinc oxide, aluminum oxide, and silicon dioxide (silica); metal chloride-based fillers such as sodium chloride and calcium chloride; metal sulfate-based fillers such as sodium sulfate and sodium hydrogen sulfate; metal nitrate-based fillers such as sodium nitrate and calcium nitrate; metal phosphate-based fillers such as sodium hydrogen phosphate and sodium dihydrogen phosphate; metal titanate-based fillers such as calcium titanate, strontium titanate, and barium titanate; metal carbonate-based fillers such as sodium carbonate and calcium carbonate; carbide-based fillers such as boron carbide and silicon carbide; nitride-based fillers such as boron nitride, aluminum nitride, and silicon nitride; metal particle-based fillers such as aluminum, nickel, magnesium, copper, zinc, and iron; silicate-based fillers such as mica, kaolin, fly ash, talc, and mica; glass powder; carbon black; and the like.

Among these, metal oxide-based fillers are preferable, and silicon dioxide is more preferable, since a crosslinked resin formed article having a high modulus of elasticity can be easily obtained.

These inorganic fillers (D) may be used either alone or in combination.

The surface of the inorganic filler (D) may be treated with a known silane-based coupling agent, titanate-based coupling agent, aluminum-based coupling agent, or the like.

The polymerizable composition used in connection with one embodiment of the invention includes the inorganic filler that consists of particles having an average particle size of 1.5 to 5.0 μm, and preferable 1.5 to 4.0 μm (hereinafter may be referred to as “inorganic filler (E)”) as the component (E).

When the inorganic fibrous support is impregnated with the polymerizable composition, the polymerizable composition penetrates the inorganic fibrous support, and spreads over the surface of the inorganic fibrous support to form a think film. The thin film forms the outer-layer part of the crosslinkable resin formed article according to one embodiment of the invention when subjected to bulk polymerization.

Since the inorganic filler (E) has a large average particle size, the inorganic filler (E) does not easily enter the spaced formed in the inorganic fibrous support when the inorganic fibrous support is impregnated with the polymerizable composition. Therefore, it is possible to obtain a crosslinkable resin formed article in which the outer-layer part is sufficiently filled with the inorganic filler by utilizing the inorganic filler (E).

Examples of the inorganic filler (E) include those mentioned above in connection with the inorganic filler (D), provided that the average particle size is larger than the average particle size of those used as the inorganic filler (D). Among these, metal hydroxide-based fillers are preferable, and magnesium hydroxide and aluminum hydroxide are more preferable, since a crosslinked resin formed article having excellent flame retardancy can be easily obtained.

These inorganic fillers (E) may be used either alone or in combination.

The surface of the inorganic filler (E) may be treated with a known silane-based coupling agent, titanate-based coupling agent, aluminum-based coupling agent, or the like.

The total content of the inorganic filler (D) and the inorganic filler (E) in the polymerizable composition is 60 to 80 wt %, and preferable 70 to 80 wt %. If the total content of the inorganic filler (D) and the inorganic filler (E) is less than 60 wt %, the effects of addition of the inorganic filler may not be sufficiently achieved. If the total content of the inorganic filler (D) and the inorganic filler (E) exceeds 80 wt %, the fluidity of the polymerizable composition may decrease, and workability may deteriorate when impregnating the inorganic fibrous support with the polymerizable composition.

The weight ratio (component (D):component (E)) of the inorganic filler (D) to the inorganic filler (E) is 5:95 to 40:60, and preferable 10:90 to 35:65. When the weight ratio (component (D):component (E)) of the inorganic filler (D) to the inorganic filler (E) is within the above range, both the inner-layer part and the outer-layer part can be sufficiently filled with the inorganic filler.

The polymerizable composition used in connection with one embodiment of the invention includes the inorganic filler (D) that consists of particles having an average particle size of 0.1 to 1.0 μm and the inorganic filler (E) that consists of particles having an average particle size of 1.5 to 5.0 μm in a specific ratio. When the inorganic fibrous support is impregnated with the polymerizable composition that includes the inorganic filler (D) having a small average particle size and the inorganic filler (E) having a large average particle size in a specific ration, it is possible to obtain an impregnated product in which only the inorganic filler (D) having a small average particle size selectively enters the inorganic fibrous support, while the inorganic filler (E) having a large average particle size remains outside the inorganic fibrous support.

The crosslinkable resin formed article according to one embodiment of the invention that includes the inner-layer part that includes the inorganic fibrous support, and the outer-layer part that is adjacent to the inner-layer part,, and does not include the inorganic fibrous support, wherein only the component (D) is dispersed in the inner-layer part, and the component (E) is dispersed in the outer-layer part, can be easily obtained by subjecting the polymerizable composition included in the impregnated product to bulk polymerization.

Note that the expression “only the component (D) is dispersed in the inner-layer part” means that only the component (D) is unevenly (locally) dispersed in the inner-layer part, and the expression “the component (E) is dispersed in the outer-layer part” means that the component (E) is unevenly (locally) dispersed in the outer-layer part.

The polymerizable composition used in connection with one embodiment of the invention may optionally include a chain transfer agent, a crosslinking promoter, a reactive fluidizing agent, a flame retardant, a modifier, a polymerization retarder, an aging preventive, and the like in addition to the components (A) to (E).

The chain transfer agent is a compound that includes a carbon-carbon double bond that can be involved in a ring-opening polymerization reaction, and can be bonded to the terminal of a polymer produced by polymerizing the cycloolefin monomer. The molecular weight of the crosslinkable resin formed article can be adjusted by adding the chain transfer agent. The chain transfer agent may include a crosslinkable carbon-carbon double bond in addition to the above carbon-carbon double bond.

Examples of the chain transfer agent include aliphatic olefins such as 1-hexene and 2-hexene; aromatic olefins such as styrene, divinylbenzene, and stilbene; alicyclic olefins such as vinylcyclohexane; vinyl ethers such as ethyl vinyl ether; vinyl ketones such as methyl vinyl ketone, 1,5-hexadien-3-one, 2-methyl-1,5-hexadien-3-one; and the like. Among these, a hydrocarbon compound that does not include a hetero atom is preferable since a crosslinked resin formed article and a laminate having a low dielectric loss tangent can be obtained.

These chain transfer agents may be used either alone or in combination.

The chain transfer agent is normally used in an amount of 0.01 to 10 parts by weight, and preferably 0.005 to 5 parts by weight, based on 100 parts by weight of the cycloolefin monomer.

The crosslinking promoter is a polyfunctional compound that includes two or more functional groups that are not involved in the ring-opening polymerization reaction, but can be involved in the crosslinking reaction induced by the crosslinking agent, and can form part of the resulting crosslinked structure. A crosslinked resin formed article and a laminate having a high crosslink density and excellent heat resistance can be obtained by adding the crosslinking promoter.

Examples of the functional group included in the crosslinking promoter include a vinylidene group. It is preferable that a vinylidene group be present in the crosslinking promoter as an isopropenyl group or a methacryloyl group (more preferably a methacryloyl group) due to excellent crosslinking reactivity.

Examples of the crosslinking promoter include compounds that include two or more isopropenyl groups, such a p-diisopropenylbenzene, m-diisopropenylbenzene, and o-diisopropenylbenzene; compounds that include two or more methacryloyl groups, such as ethylenedimethacrylate, 1,3-butylenedimethacrylate, 1,4-butylenedimethacrylate, 1,6-hexanediol dimethacrylate, polyethylene glycol dimethacrylate, polyethylene glycol dimethacrylate, ethylene glycol dimethacrylate, triethylene glycol dimethacrylate, diethylene glycol dimethacrylate, 2,2′-bis(4-methacryloxydiethoxyphenyl)propane, trimethylolpropane trimethacrylate, and pentaerythritol trimethacrylate; and the like. The crosslinking promoter is preferably a compound that includes two or more methacryloyl groups, and more preferably a compound that includes three methacryloyl groups (e.g., trimethylolpropane trimethacrylate or pentaerythritol trimethacrylate).

These crosslinking promoters may bused either alone or in combination.

The crosslinking promoter is normally used in an amount of 0.1 to 100 parts by weight, and preferably 0.5 to 50 parts by weight, based on 100 parts by weight of the cycloolefin monomer.

When the crosslinking promoter is used in an amount within the above range, it is possible to easily obtain a crosslinked resin formed article and a laminate having excellent heat resistance and a low dielectric loss tangent.

The reactive fluidizing agent is a monofunctional compound that includes one functional group that is not involved in the ring-opening polymerization reaction, but can be involved in the crosslinking reaction induced by the crosslinking agent, and can form part of the resulting crosslinked structure. The reactive fluidizing agent is present in the resin formed article in a substantially free state until the reactive fluidizing agent is involved in the crosslinking reaction to improve the plasticity of the resin formed article. Therefore, the crosslinkable resin formed article that includes the reactive fluidizing agent exhibits moderate fluidity during thermal melting, and exhibits excellent formability. Since the reactive fluidizing agent can form part of the resulting crosslinked structure in the same manner as the crosslinking promoter, the reactive fluidizing agent contributes to an improvement in heat resistance of the crosslinked resin formed article and the laminate.

Examples of the functional group included in the reactive fluidizing agent include a vinylidene group. It is preferable that a vinylidene group be present in the reactive fluidizing agent as an isopropenyl group or a methacryl group (more preferably a methacryl group) due to excellent crosslinking reactivity.

Examples of the reactive fluidizing agent include compounds that include one methacryloyl group, such as lauryl methacrylate, benzyl methacrylate, tetrahydrofurfuryl methacrylate, and methoxy diethylene glycol methacrylate; compounds that include one isopropenyl group, such as isopropenylbenzene; and the like. The reactive fluidizing agent is preferably a compound that includes one methacryloyl group.

These reactive fluidizing agents may be used either alone or in combination.

The reactive fluidizing agent is normally used in an amount of 0.1 to 100 parts by weight, and preferably 0.5 to 50 parts by weight, based on 100 parts by weight of the cycloolefin monomer.

A known halogen-based flame retardant or non-halogen-based flame retardant may be used as the flame retardant. Examples of the halogen-based flame retardant include tris(2-chloroethyl) phosphate, tris(chloropropyl) phosphate, tris(dichloropropyl) phosphate, chlorinated polystyrene, chlorinated polyethylene, highly chlorinated polypropylene, chlorosulfonated polyethylene, hexabromobenzene, decabromodiphenyl oxide, bis(tribromophenoxy)ethane, 1,2-bis(pentabromophenyl)ethane, tetrabromobisphenol S, tetradecabromodiphenoxybenzene, 2,2-bis(4-hydroxy-3,5-dibromophenylpropane), pentabromotulune, and the like.

Examples of the non-halogen-based flame retardant include metal hydroxide-based blame retardants such as aluminum hydroxide and magnesium hydroxide; metal oxide-based flame retardants such as magnesium oxide and aluminum oxide; phosphorus-based flame retardants such as triphenyl phosphate , tricresyl phosphate, trixylenyl phosphate, cresyldiphenyl phosphate, resorcinol bis(diphenyl phosphate), bisphenol A bis(diphenyl phosphate), and bisphenol A bis(dicresyl phosphate); nitrogen-based flame retardants such as melamine derivatives, guanidines, and isocyanuric acid; flame retardants that include a phosphorus atom and a nitrogen atom, such as ammonium polyphosphate, melamine phosphate, melamine polyphosphate, melam polyphosphate, guanidine phosphate, and phosphazenes; and the like.

These flame retardants may be used either alone or in combination.

The flame retardant is normally used in an amount of 10 to 300 parts by weight, preferably 20 to 200 parts by weight, and more preferably 30 to 150 parts by weight based on 100 parts by weight of the cycloolefin monomer.

The modifier is a compound that can control polymerization activity. Examples of the modifier include a trialkoxyaluminum, a triphenoxyaluminum, a dialkoxyalkylaluminum, an alkoxydiakylaluminum, a trialkylaluminum, a dialkoxyaluminum chloride, an alkoxyalkyaluminum chloride, a dialkyaluminum chloride, a trialkoxyscandium, a tetraalkoxytitanium, a tetraalkoxytin, a tetraalkoxyzirconium, and the like.

These modifiers may be used either alone or in combination. The modifier is normally used so that the molar ratio of the metal atoms included in the metathesis polymerization catalyst to the modifier (metal atoms included in metathesis polymerization catalyst:modifier) is 1:0.05 to 1:100, preferably 1:0.2 to 1:20, and more preferably 1:0.5 to 1:10.

The polymerization retarder is a compound that can suppress an increase in viscosity of the polymerizable composition. Examples of the polymerization retarder include phosphine compounds such as triphenylphosphine, tributylphosphine, trimethylphosphine, triethylphosphine, dicyclohexylphosphine, vinyldiphenylphosphine, allyldiphenylphosphine, triallyphosphine, and styryldiphenylphosphine; Lewis bases such as aniline and pyridine; and the like.

These polymerization retarders may be used either alone or in combination. The content of the polymerization retarder may be appropriately adjusted.

Examples of the aging preventive include known aging preventives such as a phenol-based aging preventive, an amine-based aging preventive, a phosphorus-based aging preventive, and a sulfur-based aging preventive. Among these, a phenol-based aging preventive and an amine-based aging preventive are preferable, and a phenol-based aging preventive is more preferable. When the polymerizable composition includes the aging preventive, a crosslinked resin formed article and a laminate having excellent heat resistance can be obtained.

These aging preventives may be used either alone or in combination. The aging preventive is normally used in an amount of 0.0001 to 10 parts by weight, preferably 0.001 to 5 parts by weight, and more preferably 0.01 to 2 parts by weight, based on 100 parts by weight of the cycloolefin monomer.

Examples of additional additives include a coloring agent a light stabilizer, a pigment, a blowing agent and the like. The additional additives may respectively be used either alone or in combination. The content of each additional additive is appropriately selected so that the advantageous effects of the invention are not impaired.

The viscosity of the polymerizable composition used in connection with one embodiment of the invention is normally 10 Pa·s or less, preferably 0.01 to 5Pa·s, more preferably 0.01 to 1 Pa·s, and still more preferably 0.01 to 0.5 Pa·s.

Since the polymerizable composition used in connection with one embodiment of the invention includes the cycloolefin monomer (A) as an essential component, the polymerizable composition has low viscosity within the above range even if a large amount of dilution solvent is not used.

Moreover, the content of the components (D) and (E) in the polymerizable composition can be increased while preventing a situation in which workability during the application step and the like deteriorates due to an increase in viscosity of the polymerizable composition.

The polymerizable composition used in connection with one embodiment of the invention may be prepared by mixing the above components. The components may be mixed using a normal method. For example, a solution (dispersion) (catalyst solution) in which the metathesis polymerization catalyst (component (B)) is dissolved or dispersed in an appropriate solvent, and a solution (monomer solution) that includes the cycloolefin monomer (component (A)), the crosslinking agent (Component (C)), the inorganic filler (components (D) and (E)), and an optional additive may be prepared. The catalyst solution may be added to the monomer solution, and the mixture may be stirred to prepare the polymerizable composition.

### Crosslinkable Resin Formed Article

The crosslinkable resin formed article according to one embodiment of the invention is obtained by impregnating the inorganic fibrous support with the polymerizable composition, and subjecting the polymerizable composition to bulk polymerization.

The inorganic fibrous support is a sheet-like support formed of inorganic fibers. The type of the inorganic fibrous support is not particularly limited. It is preferable to use an inorganic fibrous support that can improve the strength of the resulting crosslinkable resin formed article and the crosslinked resin formed article, and has spaces that allow entrance of the component (D), but do not allow entrance of the component (E).

Examples of the inorganic fibers that form the inorganic fibrous support include glass fibers, carbon fibers, alumina fibers, tungsten fibers, molybdenum fibers, titanium fibers, steel fibers, boron fibers, silicon carbide fibers, silica fibers, and the like. Among these, glass fibers formed of quartz glass, T-glass, E-glass, NE-glass, S-glass, D-glass, H-glass, and the like are preferable.

A known glass cloth used for a printed circuit board may be used as the inorganic fibrous support formed of glass fibers (hereinafter may be referred to as “glass cloth”).

It is preferable to use a glass cloth that meets the following requirements since a resin formed article that exhibit is sufficient strength can be obtained, and the glass cloth has spaces that allow easy entrance of the component (D), but do not allow easy entrance of the component (E).
The glass cloth is preferably woven by plain weave, mat weave, twill weave, satin weave, mock leno weave, leno weave, or the like.
The thickness of the glass cloth is normally 10 to 100 μm, and preferable 10 to 50 μm.
The weaving density of the glass cloth is normally 10 to 100 yarns/25 mm, and preferably 10 to 50 yarns/25 mm.
The weight of the glass cloth per unit area is normally 10 to 300 g/m², and preferably 10 to 250 g/m².

The inorganic fibrous support may be impregnated with the polymerizable composition by applying the polymerizable composition to the inorganic fibrous support, and pressing the surface of the inorganic fibrous support to which the polymerizable composition has been applied using a roller, for example.

In this case, a protective film may be placed between the roller and the inorganic fibrous support.

Alternatively, the polymerizable composition may be cast onto a sheet-like support, the inorganic fibrous support may be placed thereon, the polymerizable composition may be applied to the inorganic fibrous support, and the surface of the inorganic fibrous support to which the polymerizable composition has been applied may be pressed.

The polymerizable composition may be applied (cast) using an arbitrary method (e.g., spray coating method, dip coating method, roll coating method, curtain coating method, die coating method, or slit coating method).

Examples of the protective film include resin films formed of polytetrafluoroethylene, polyethylene terephthalate, polypropylene, polyethylene, polycarbonate, polyethylene naphthalate, polyarylate, nylon, and the like. The surface of these resin films may be subjected to a release treatment.

Examples of the sheet-like support include the resin films mentioned above in connection with the protective film; metal foils formed of metal materials such as iron, stainless steel, copper, aluminum, nickel, chromium, gold, and silver; and the like.

The thickness of the sheet-like support is normally 1 to 150 μm, preferably 2 to 100 μm, and more preferably 3 to 75 μm, from the viewpoint of workability and the like.

When using a metal foil as the sheet-like support, it is preferable that the metal foil have a flat and smooth surface. The surface roughness (Rz) of the metal foil measured using an atomic force microscope (AFM) is normally 10 μm or less, preferably 5 μm or less, more preferably 3 μm or less, and still more preferably 2 μm or less. When the surface roughness of the metal foil is within the above range, noise, a delay, a transmission (propagation) loss, and the like during high-frequency transmission (propagation) can be suppressed when using the resulting high-frequency circuit board, for example. It is preferable that the surface of the metal foil be treated with a known coupling agent (e.g., silane coupling agent, thiol coupling agent, or titanate coupling agent), and adhesive, or the like.

The polymerizable composition with which the inorganic fibrous support has been impregnated, is optionally dried, and subjected to bulk polymerization. The polymerizable composition is normally subjected to bulk polymerization by heating the polymerizable composition to a specific temperature. The polymerizable composition may be heated using an arbitrary method. For example, the polymerizable composition may be heated using a method that heats the polymerizable composition placed on a heating plate, a method that heats the polymerizable composition while applying pressure using a press (hot pressing), a method that presses the polymerizable composition using a heated roller, or a method that heats the polymerizable composition in a hating furnace.

The polymerizable composition is normally subjected to bulk polymerization at a temperature of 30 to 250° C., preferably 50 to 200° C., and more preferably 90 to 150° C. The heating temperature is normally set to be equal to or lower than the one-minute half-life temperature of the crosslinking agent (normally a radical generator), preferably equal to or lower than the one-minute half-life temperature of the crosslinking agent by 10° C. or more, and more preferably equal to or lower than the one-minute half-life temperature of the crosslinking agent by 20° C. or more. The polymerization time may be appropriately selected, but is normally 1 second to 20 minutes, and preferably 10 seconds to 5 minutes. A crosslinkable resin formed article that includes only a small amount of unreacted monomers can be obtained by heating the polymerizable composition under the above condition.

When a resin sheet is used as the sheet-like support, a crosslinkable resin formed article provided with a resin sheet can be obtained by bulk polymerization.

A resin-coated copper (RCC) foil can be obtained when a copper foil is used as the sheet-like support.

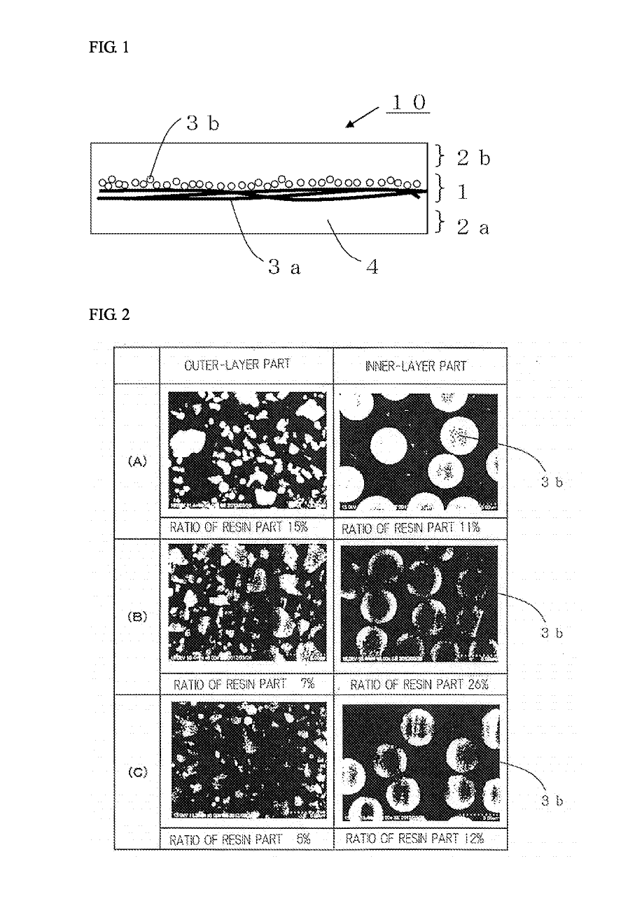

FIG. 1 is a schematic view illustrating the cross section of the crosslinkable resin formed article according to one embodiment of the invention. More specifically, FIG. 1 illustrated the overlapping area of warp and weft when the crosslinkable resin formed article is cut along the weft of the inorganic fibrous support formed of warp and weft. A crosslinkable resin formed article (10) includes an inner-layer part (1), an outer-layer part I (2a), and an outer-layer part II (2b). The inner-layer part (1) includes an inorganic fibrous support formed of inorganic fibers (3a) (weft) and inorganic fibers (3b) (warp). The outer-layer part I (2a) and the outer-layer part II (2b) are situated on either side of the inner-layer part (1). Each of the inner-layer part (1), the outer-layer part I (2a), and the outer-layer part II (2b) includes components (4) (e.g., crosslinkable resin and inorganic filler) derived from the polymerizable composition.

The thickness of the inner-layer part (1) is normally 5 to 100 μm, and preferably 20 to 50 μm.

The thickness of the outer-layer part I (2a) and the outer-layer part II (2b) is normally 20 to 40 μm, and preferably 5 to 10 μm.

The thickness of the crosslinkable resin formed article (10) is normally 10 to 200 μm, and preferable 30 to 70 μm.

A layer structure is formed by impregnating the inorganic fibrous support with the polymerizable composition.

Since the inorganic filler (D) having a small average particle size can easily enter the spaces formed in the inorganic fibrous support, and the inorganic filler (E) having a large average particle size cannot easily enter the spaces formed in the inorganic fibrous support, an impregnated product is obtained in which only the inorganic filler (D) is dispersed in the inner-layer part (1) (not illustrated in the drawings), and the inorganic filler (E) is dispersed in the outer-layer part I (2a) and the outer-layer part II (2b) (not illustrated in the drawings).

In particular, dispersion of the inorganic filler (D) and the inorganic filler (E) is promoted by utilizing the polymerizable composition having low viscosity.

Whether or not the inorganic filler (D) and the inorganic filler (E) are dispersed in the resulting resin formed article may be determined by energy-dispersive X-ray spectrometry (EDX).

Since the inorganic filler (D) and the inorganic filler (E) are dispersed as described above, it is possible to control the degree of filling with the filler included in the crosslinkable resin formed article according to one embodiment of the invention, corresponding to the inner-layer part and the outer-layer part, by adjusting the content of the inorganic filler (D) and the content of the inorganic filler (E) in the polymerizable composition. Therefore, it is possible to efficiently increase the degree of filling with the inorganic filler in the crosslinkable resin formed article according to one embodiment of the invention. Note that the inorganic filler (D) and the inorganic filler (E) are dispersed in specific layers of the crosslinkable resin formed article according to one embodiment of the invention. Specifically, the inorganic filler (D) is included n only the inner-layer part, and the inorganic filler (E) is included in only the outer-layer part.

It is possible to obtain a crosslinkable resin formed article having higher performance by utilizing dispersion of the inorganic filler (D) and the inorganic filler (E). Specifically, it is possible to selectively fill the inner-layer part and the outer-layer part with a specific inorganic filler by changing the type of the inorganic filler (D) and the type of the inorganic filler (E) taking account of the objective.

For example, when silicon dioxide is used as the inorganic filler (D), silicon dioxide is locally dispersed in the inner-layer part, and the storage modulus and the flexural modulus of the resin formed article can be efficiently improved. When a metal hydroxide is used as the inorganic filler (E), the metal hydroxide is locally dispersed in the outer-layer part, and the flame retardancy of the resin formed article can be efficiently improved.

The crosslinkable resin (i.e., a polymer of the cycloolefin monomer) that forms the crosslinkable resin formed article according to one embodiment of the invention substantially does not have a crosslinked structure, and is soluble in toluene, for example. The polystyrene-reduced weight average molecular weight of the crosslinkable resin determined by gel permeation chromatography (eluant: tetrahydrofuran) is normally 1000 to 1,000,000, preferably 5000 to 500,000, and more preferably 10,000 to 100,000.

The crosslinkable resin formed article according to one embodiment of the invention is a resin formed article that can be post-crosslinked. Note that part of the crosslinkable resin may have been crosslinked. For example, when subjecting the polymerizable composition to bulk polymerization, the temperature may increase to a large extent in an area in which the heat of the polymerization reaction is not easily released. A crosslinking reaction may occur in such a high-temperature area, and the resin may be partially crosslinked. However, the crosslinkable resin formed article according to one embodiment of the invention sufficiently achieves the intended effects as long as the area (normally the surface area) of the crosslinkable resin formed article that easily releases heat is formed of a crosslinkable resin that can be post-crosslinked.

The crosslinked resin formed article according to one embodiment of the invention is obtained upon completion of bulk polymerization of the polymerizable composition, and a situation in which the polymerization reaction further proceeds during storage does not occur. The crosslinkable resin formed article according to one embodiment of the invention includes the crosslinking agent (e.g., radical generator). However, a change in surface hardness or the like does not occur as long as the crosslinkable resin formed article is not heated to a temperature equal to or higher than the temperature at which the crosslinking reaction occurs. Therefore, the crosslinkable resin formed article exhibits excellent storage stability.

### 2) Crosslinked Resin Formed Article

A crosslinked resin formed article according to one embodiment of the invention is obtained by crosslinking the crosslinkable resin formed article according to one embodiment of the invention. The dispersion state of the inorganic filler (D) and the inorganic filler (E) in the crosslinkable resin formed article is maintained in the crosslinked resin formed article.

The crosslinking reaction may be effected by heating the crosslinkable resin formed article to a temperature equal to or higher than a specific temperature. The heating temperature is normally set to be equal to or higher than the temperature at which the crosslinking reaction is induced by the crosslinking agent. For example, when using a radical generator as the crosslinking agent, the heating temperature is normally set to a temperature equal to or higher than the one-minute half-life temperature of the radical generator, preferably a temperature higher than the one-minute half-life temperature of the radical generation by 5° C. or more, and more preferably a temperature higher than the one-minute half-life temperature of the radical generator by 10° C. or more. The heating temperature is typically 100 to 300° C., and preferably 150 to 250° C. The heating time is normally 0.1 to 180 minutes, preferably 0.5 to 120 minutes, and more preferably 1 to 60 minutes.

It is also possible to effect a bulk polymerization reaction and a crosslinking reaction to obtain the crosslinked resin formed article according to one embodiment of the invention by casting the polymerizable composition onto a sheet-like support, placing the inorganic fibrous support thereon, impregnating the inorganic fibrous support with the polymerizable composition, and heating the polymerizable composition to a temperature at which the crosslinking reaction occurs.

According to this method, it is possible to obtain a resin-coated copper (RCC) foil when a copper foil is used as the sheet-like support, for example.

The crosslinked resin formed article according to one embodiment of the invention is sufficiently filled with the filler, and normally has the following properties.

The storage modulus at 260° C. of the crosslinked resin formed article is normally 1.0×10⁹ Pa or more, and preferable 1.0>10⁹ to 1.0×10¹¹ Pa.

The glass transition temperature of the crosslinked resin formed article is normally 240° C. or more, and preferable 240 to 400° C.

The dielectric loss tangent (tan δ) of the crosslinked resin formed article is normally less than 0.15, and preferably 0.01 or more and less than 0.15.

The flexural modulus at 30° C. of the crosslinked resin formed article is normally 28 GPa or more, and preferably 28 to 50 GPa.

The storage modulus, the glass transition temperature, the dielectric loss tangent (tan δ), and the flexural modulus may be measured using the methods described in connection with the examples.

The crosslinked resin formed article according to one embodiment of the invention that has the above properties has a high modulus of elasticity in a high temperature range that exceeds the glass transition temperature of the crosslinked resin that forms the formed article, and exhibits excellent heat resistance and excellent flame retardancy. A printed circuit board is normally subjected to a high temperature up to 260° C. during a solder reflow step that secures an electronic part on the surface thereof, for example. In this case, stress occurs due to the difference in coefficient of linear expansion between an insulating substrate that forms the printed circuit board and a copper foil that forms a conductive pattern, whereby the substrate may warp. However, since the crosslinked resin formed article according to one embodiment of the invention has a high storage modulus in such a high temperature range, and exhibits high strength, a printed circuit board that is produced using the formed article as the insulating substrate substantially does not show such warping. Therefore, the crosslinked resin formed article according to one embodiment of the invention is very useful as a material for producing a printed circuit board.

### 3) Laminate

A laminate according to one embodiment of the invention is produced by stacking the crosslinkable resin formed article or the crosslinked resin formed articles. The laminate according to one embodiment of the invention may be a laminate that is obtained by directly stacking the crosslinkable resin formed articles or the crosslinked resin formed articles, or may be a laminate that is produced by stacking the crosslinkable resin formed articles or the crosslinked resin formed articles through another layer. The crosslinkable resin formed articles or the crosslinked resin formed articles that are stacked to produce the laminate may be formed of an identical resin, or may be formed of different resins.

Examples of the laminate according to one embodiment of the invention include an RCC foil in which a copper foil and the crosslinkable resin formed article are integrated in layers. Examples of the laminate produced by stacking the crosslinked resin formed articles according to one embodiment of the invention include a CCL in which a copper foil and the crosslinked resin formed article are integrated in layers.

The laminate according to one embodiment of the invention may be produced by stacking the crosslinkable resin formed articles according to one embodiment of the invention optionally together with the crosslinked resin formed article, a metal foil, a laminate (E.g., RCC or CCL), or the like, and hot-pressing the resulting laminate.

For example, a plurality of crosslinkable formed articles provided with a resin sheet which have bee obtained using the above method and from which the resin sheet has been removed, may be stacked to obtain a laminate, and a metal foil may be stacked on each side of the laminate, followed by hot pressing to obtain a metal-clad laminated sheet.

The hot-pressing is normally 0.5 to 20 MPa, and preferable 3 to 10 MPa. Hot pressing may be performed under vacuum or reduced pressure. Hot pressing may be performed using a known press having a flat press mold, or a press molding machine used for a sheet molding compound (SMC) or a bulk molding compound (BMC), for example.

The laminate according to one embodiment of the invention has a very small dielectric loss tangent in a high-frequency region, and exhibits excellent heat resistance. The laminate according to one embodiment of the invention having the above properties may widely and suitably be used as a high-speed/high-frequency substrate material. Specifically, the laminate according to one embodiment of the invention may suitably be used for a multilayer substrate used for information devices, and a high-frequency circuit board (e.g., microwave or millimeter-wave circuit board) used for communication devices.

### EXAMPLES

The invention is further described below by way of examples and comparative examples. Note that the units “parts” and “%”) used in connection with the examples and comparative examples respectively refer to “parts by weight” and “wt %” unless otherwise indicated.

The properties were defined and evaluated using the following methods.

### (1) Storage Modulus of Crosslinked Resin Formed Article

The copper foil was removed by etching the laminate to obtain a specimen. The storage modulus (Pa) at 260° C. of the specimen was measure using a viscoelasticity spectrometer (“DMS 6100 (standard type)” manufactured by SII NanoTechnology), and evaluated in accordance with the following standard.

Good: 1.0×10⁹ Pa or more
Poor: Less than 1.0×10⁹ Pa

### (2) Flexural Modulus of Crosslinked Resin Formed Article

The copper foil was removed by etching eh laminate to obtain a specimen. The flexural modulus at 30° C. of the specimen was measured in accordance with JIS K 7074, and evaluated in accordance with the following standard.

Good: 28 GPa or more
Poor: Less than 28 GPa

### (3) Glass Transition Temperature of Crosslinked Resin Formed Article

The copper foil was removed by etching the laminate to obtain a specimen. The glass transition temperature (°C) of the specimen was measured using a viscoelasticity spectrometer (“DMS 6100 (standard type)” manufactured by SII NanoTechnology), and evaluated in accordance with the following standard.

Good: 240° C. or more
Poor: Less than 240° C.
(4) Dielectric Loss tangent (tan δ) of Crosslinked Resin Formed Article

The copper foil was removed by etching the laminate to obtain a specimen. The dielectric loss tangent (tan δ) of the specimen was measured at a frequency of 1 Hz using a viscoelasticity spectrometer (“DMS 6100 (standard type)” manufactured by SII NanoTechnology), and evaluated from the top peak value in accordance with the following standard.

Good: Less then 0.15
Poor: 0.15 or more

### (5) Flame Retardancy of Crosslinked Resin Formed Article

The copper foil was removed by etching the laminate, an the laminate was cute to obtain a strip-shaped specimen having dimensions of 125×15×0.4 mm. The specimen was placed vertically. A flame was applied to the lower end of the specimen for 10 seconds, and removed from the specimen. The state of the specimen was then observed, and the flame retardancy of the specimen was evaluated in accordance with the following standard.

Good: Flaming did not occur after flame removal.
Fair: flaming occurred after flame removal, bat stopped at a distance of less than 9 cm from the lower end of the specimen.
Poor: Flaming occurred after flame removal, and did not stop at a distance of less than 9 cm from the lower end of the specimen.

The following compounds were used to the examples and comparative examples.

### (1) Cycloolefin Monomer

TCDMA: 2-methacryloyloxyethyl tetracyclo[4.4.0.1^{2,5}.1^{7,10}]dodec-3-ene-3-carboxylate
MAc-NB: 5-norbornen-2-yl methacrylate
ETD: ethylidenetetracyclo[6.2.1.1^{3,6}.0^{2,7}]dodec-4-ene

### (2) Metathesis Polymerization Catalyst

Metathesis polymerization catalyst 1:
benzylidene(1,3-dimesitylimidazolidin-2-ylidne)(tricyclohexylphosphine)ruthenium dichloride

### (3) Crosslinking Agent

Crosslinking agent 1: di-t-butyl peroxide (one-minute half-life temperature: 186° C.)

### (4) Crosslinking Promoter

Crosslinking promoter 1: trimethylopropane trimethacrylate

### (5) Inorganic Filler

Inorganic filler 1: silicon dioxide (treated with a coupling agent, average particle size: 0.5 μm)
Inorganic filler 2: silicon dioxide (treated with a coupling agent, average particle size: 1.6 μm)
Inorganic filler 3: aluminum hydroxide (average particle size: 2.7 μm)
Inorganic filler 4: magnesium hydroxide (average particle size: 1.8 μm)

### Example 1

0.05 parts of the metathesis polymerization catalyst 1 and 0.01 parts of triphenylphosphine were dissolved in 1.51 parts of indene to prepare a catalyst solution. Separately, a glass vessel was charged with 30 parts of TCDMA (cycloolefin monomer), 70 parts of ETD (cycloolefin monomer), 0.85 parts of styrene (chain transfer agent), 1.14 parts of the crosslinking agent 1, and 20 parts of the crosslinking promoter 1. After the addition of 80 parts of the inorganic filler 1, 160 parts of the inorganic filler 3, and 120 parts of the inorganic filler 4 to the mixture, the resulting mixture was homogenously mixed to prepare a monomer liquid. The catalyst solution was mixed with the monomer liquid to obtain a polymerizable composition 1.

The polymerizable composition 1 was cast onto a polyethylene naphthalate film (thickness: 75 μm), and a glass clothe (E-glass, IPC spec 1078) was placed thereon. the polymerizable composition 1 was cast onto the glass cloth, and a polyethylene naphthalate film was placed thereon. The resulting laminate was pressed using a roller to impregnate the glass cloth with the polymerizable composition 1.

The polymerizable composition 1 was polymerized at 120° C for 3.5 minutes to obtain a crosslinkable resin formed article 1 having a thickness of 0.06 mm.

Seven crosslinkable resin formed articles 1 were provided. After removing the polyethylene naphthalate film, the crosslinkable resin formed articles 1 were stacked. An electrodeposited copper foil (“Type F0” manufactured by Furukawa Electric Co., Ltd., treated with a silane coupling agent, thickness: 0.012 mm) was placed on each side of the resulting laminate. The resulting laminate was hot-pressed at 200° C. for 15 minutes under a pressure of 3 MPa to obtain a laminate 1 having a thickness of 0.4 mm.

The properties were measured as described above using the laminate 1.

Table 1 shows the composition of the polymerizable composition 1, and Table 2 shows the evaluation results.

### Example 2

A polymerizable composition 2 was obtained in the same manner as in Example 1, except that the amount of TCDMA was changed from 30 parts to 35 parts, and the amount of ETD was changed from 70 parts to 65 parts.

A crosslinkable resin formed article 2 and a laminate 2 were produced in the same manner as in Example 1, except that the polymerizable composition 2 was used instead of the polymerizable composition 1, and the properties were measure as described above.

Table 1 shows the composition of the polymerizable composition 2, and Table 2 shows the evaluation results.

### Example 3

A polymerizable composition 3 was obtained in the same manner as in Example 1, except that the amount of TCDMA was changed from 30 parts to 40 parts, and the amount of ETD was changed from 70 parts to 60 parts.

A crosslinkable resin formed article 3 and a laminate 3 were produced in the same manner as in Example 1, except that the polymerizable composition 3 was used instead of the polymerizable composition 1, and the properties were measured as described above.

Table 1 shows the composition of the polymerizable composition 3, and Table 2 shows the evaluation results.

### Example 4

A polymerizable composition 4 was obtained in the same manner as in Example 1, except that 30 parts of Mac-NB was used instead of 30 parts TCDMA.

A crosslinkable resin formed article 4 and a laminate 4 were produced in the same manner as in Example 1, except that the polymerizable composition 4 was used instead of the polymerizable composition 1, and the properties were measured as described above.

Table 1 shows the composition of the polymerizable composition 4, and Table 2 shows the evaluation results.

### Example 5

A polymerizable composition 5 was obtained in the same manner as in example 2, except that 35 parts of the MAc-NB was used instead of 35 parts of TCDMA.

A crosslinkable resin formed article 5 and a laminate 5 were produced in the same manner as in Example 1, except that the polymerizable composition 5 was used instead of the polymerizable composition 1, and the properties were measured as described above.

Table 1 shows the composition of the polymerizable composition 5, and Table 2 shows the evaluation results.

### Example 6

A polymerizable composition 6 was obtained in the same manner as in Example 3, except that 40 parts of MAC-NB was used instead of 40 parts of TCDMA.

A crosslinkable resin formed article 6 and a laminate 6 were produced in the same manner as in Example 1, except that the polymerizable composition 6 was used instead of the polymerizable composition 1, and the properties were measured as described above.

Table 1 shows the composition of the polymerizable composition 6, and Table 2 shows the evaluation results.

### Comparative Example 1

0.05 parts of the metathesis polymerization catalyst 1 and 0.01 parts of triphenylphosphine were dissolved in 1.51 parts of indene to prepare a catalyst solution. Separately, a glass vessel was charged with 35 parts of TCDMA (cycloolefin monomer), 65 parts of ETD (cycloolefin monomer), 0.85 parts of styrene (chain transfer agent), 1.14 parts of the crosslinking agent 1, and 20 parts of the crosslinking promoter 1. After the addition of 80 parts of the inorganic filler 1 to the mixture, the resulting mixture was homogenously mixed to prepare a monomer liquid. The catalyst solution was mixed with the monomer liquid to obtain a polymerizable composition 7.

The polymerizable composition 7 was cast onto a polyethylene naphthalate film (thickness: 75 μm), and a glass cloth (E-glass, IPC spec 1078) was placed thereon. The polymerizable composition 7 was cast onto the glass cloth, and a polyethylene naphthalate film was placed thereon. The resulting laminate was pressed using a roller to impregnate the glass cloth with the polymerizable composition 7.

The polymerizable composition 7 was polymerized at 129° C. for 3.5 minutes to obtain a crosslinkable resin formed article 7a having a thickness of 0.04. mm.

After removing the polyethylene naphthalate film, the polymerizable composition 2 obtained in Example 2 was applied to each side of the crosslinkable resin formed article 7a. The polymerizable composition 2 was polymerized at 120° C. for 3.5 minutes to obtain a crosslinkable resin formed article 7 having a thickness of 0.06 mm.

A laminate 7 was produced in the same manner as in Example 1, except that the crosslinkable resin formed article 7 was used instead of the crosslinkable resin formed article 1, and the properties were measured as described above.

Table 1 shows the composition of the polymerizable composition 2 and 7, and Table 2 shows the evaluation results.

### Comparative Example 2

0.05 parts of the metathesis polymerization catalyst 1 and 0.01 parts of triphenylphosphine were dissolved in 1.51 parts of indene to prepare a catalyst solution. Separately, a glass vessel was charged with 35 parts of TCDMA (cycloolefin monomer), 65 parts of ETD (cycloolefin monomer), 0.85 parts of styrene (chain transfer agent), 1.14 parts of the crosslinking agent 1, and 20 parts of the crosslinking promoter 1. After the addition of 160 parts of the inorganic filler 3 and 120 parts of the inorganic filler 4 to the mixture, the resulting mixture was homogenously mixed to prepare a monomer liquid. The catalyst solution was mixed with the monomer liquid to obtain a polymerizable composition 8.

A crosslinkable resin formed article 8 and a laminate 8 were produced in the same manner as in Comparative Example 1, except that the polymerizable composition 8 was used instead of the polymerizable composition 2, and the properties were measured as described above.

Table 1 shows the composition of the polymerizable composition 7 and 8, and Table 2 shows the evaluation results.

### Comparative Example 3

A polymerizable composition 9 was obtained in the same manner as in Example 2, except that the inorganic filler 1 was not used.

A crosslinkable resin formed article 9 and laminate 9 were produced in the same manner as in Example 1, except that the polymerizable composition 9 was used instead of the polymerizable composition 1, and the properties were measured as described above.

Table 1 shows the composition of the polymerizable composition 9, and Table 2 shows the evaluation results.

### Comparative Example 4

A polymerizable composition 10 was obtained in the same manner as in Example 2, except that the inorganic filler 2 was used instead of the inorganic filler 1.

A crosslinkable resin formed article 10 and a laminate 10 were produced in the same manner as in Example 1, except that the polymerizable composition 10 was used instead of the polymerizable composition 1, and the properties were measured as described above.

Table 1 shows the composition of the polymerizable composition 10, and Table 2 shows the evaluation results.

### Comparative Example 5

0.05 parts of the metathesis polymerization catalyst and 0.01 parts of triphenylphosphine were dissolved in 1.51 parts of indene to prepare a catalyst solution. Separately, a glass vessel was charged with 35 parts of TCDMA (cycloolefin monomer), 65 parts of ETD (cycloolefin monomer), 0.85 parts of styrene (chain transfer agent), 1.14 parts of the crosslinking agent, and 20 parts of the crosslinking promoter 1. After the addition of 60 parts of the inorganic filler 1 and 50 parts of the inorganic filler 3 to the mixture, the resulting mixture was homogenously mixed to prepare a monomer liquid. The catalyst solution was mixed with the monomer liquid to obtain a polymerizable composition 11.

A crosslinkable resin formed article article 11 and a laminate 11 were produced in the same manner as in Example 1, except that the polymerizable composition 11 was used instead of the polymerizable composition 1, and the properties were measured as described above.

Table 1 shows the composition of the polymerizable composition 11, and Table 2 shows the evaluation results.

TABLE 1

| | | | Example | | | | | |
|---|---|---|---|---|---|---|---|---|
| | | | 1 | 2 | 3 | 4 | 5 | 6 |
| Number of application steps | | | 1 | 1 | 1 | 1 | 1 | 1 |
| Polymerizable | Cycloolefin | TCDMA (parts by weight) | 30 | 35 | 40 | — | — | — |
| composition A | monomer | Mac-NB (parts by weight) | — | — | — | 30 | 35 | 40 |
| | | ETD (parts by weight) | 70 | 65 | 60 | 70 | 65 | 60 |
| | Metathesis polymerization catalyst 1 | | 0.05 | 0.05 | 0.05 | 0.05 | 0.05 | 0.05 |
| | (parts by weight) | | | | | | | |
| | Crosslinking agent 1 (parts by weight) | | 1.14 | 1.14 | 1.14 | 1.14 | 1.14 | 1.14 |
| | Crosslinking promoter (parts by weight) | | 20 | 20 | 20 | 20 | 20 | 20 |
| | Chain transfer agent (parts by weight) | | 0.85 | 0.85 | 0.85 | 0.85 | 0.85 | 0.85 |
| | Inorganic | Inorganic filler 1 (0.5 μm) | 80 | 80 | 80 | 80 | 80 | 80 |
| | filler | (parts by weight) | | | | | | |
| | | Inorganic filler 2 (1.6 μm) | — | — | — | — | — | — |
| | | (parts by weight) | | | | | | |
| | | Inorganic filler 3 (2.7 μm) | 160 | 160 | 160 | 160 | 160 | 160 |
| | | (parts by weight) | | | | | | |
| | | Inorganic filler 4 (1.8 μm) | 120 | 120 | 120 | 120 | 120 | 120 |
| | | (parts by weight) | | | | | | |
| | | Total content (wt %) | 75 | 75 | 75 | 75 | 75 | 75 |
| | | in composition | | | | | | |
| | | Component (D):component (E) | 22:78 | 22:78 | 22:78 | 22:78 | 22:78 | 22:78 |
| Polymerizable | Cycloolefin | TCDMA (parts by weight) | — | — | — | — | — | — |
| composition B | monomer | Mac-NB (parts by weight) | — | — | — | — | — | — |
| | | ETD (parts by weight) | — | — | — | — | — | — |
| | Metathesis polymerization catalyst | | — | — | — | — | — | — |
| | (parts by weight) | | | | | | | |
| | Crosslinking agent (parts by weight) | | — | — | — | — | — | — |
| | Crosslinking promoter (parts by weight) | | — | — | — | — | — | — |
| | Chain transfer agent (parts by weight) | | — | — | — | — | — | — |
| | Inorganic | Inorganic filler 1 (0.5 μm) | — | — | — | — | — | — |
| | filler | (parts by weight) | | | | | | |
| | | Inorganic filler 2 (1.6 μm) | — | — | — | — | — | — |
| | | (parts by weight) | | | | | | |
| | | Inorganic filler 3 (2.7 μm) | — | — | — | — | — | — |
| | | (parts by weight) | | | | | | |
| | | Inorganic filler 4 (1.8 μm) | — | — | — | — | — | — |
| | | (parts by weight) | | | | | | |
| | | Total content (wt %) | — | — | — | — | — | — |
| | | in composition | | | | | | |
| | | Component (D):component (E) | — | — | — | — | — | — |

| | | | Comparative Example | | | | |
|---|---|---|---|---|---|---|---|
| | | | 1 | 2 | 3 | 4 | 5 |
| Number of application steps | | | 2 | 2 | 1 | 1 | 1 |
| Polymerizable | Cycloolefin | TCDMA (parts by weight) | 35 | 35 | 35 | 35 | 35 |
| composition A | monomer | Mac-NB (parts by weight) | — | — | — | — | — |
| | | ETD (parts by weight) | 65 | 65 | 65 | 65 | 65 |
| | Metathesis polymerization catalyst 1 | | 0.05 | 0.05 | 0.05 | 0.05 | 0.05 |
| | (parts by weight) | | | | | | |
| | Crosslinking agent 1 (parts by weight) | | 1.14 | 1.14 | 1.14 | 1.14 | 1.14 |
| | Crosslinking promoter (parts by weight) | | 20 | 20 | 20 | 20 | 20 |
| | Chain transfer agent (parts by weight) | | 0.85 | 0.85 | 0.85 | 0.85 | 0.85 |
| | Inorganic | Inorganic filler 1 (0.5 μm) | 80 | 80 | — | — | 60 |
| | filler | (parts by weight) | | | | | |
| | | Inorganic filler 2 (1.6 μm) | — | — | — | 80 | — |
| | | (parts by weight) | | | | | |
| | | Inorganic filler 3 (2.7 μm) | — | — | 160 | 160 | 50 |
| | | (parts by weight) | | | | | |
| | | Inorganic filler 4 (1.8 μm) | — | — | 120 | 120 | — |
| | | (parts by weight) | | | | | |
| | | Total content (wt %) | — | — | 70 | 75 | 48 |
| | | in composition | | | | | |
| | | Component (D):component (E) | — | — | — | — | 55:45 |
| Polymerizable | Cycloolefin | TCDMA (parts by weight) | 35 | 35 | — | — | — |
| composition B | monomer | Mac-NB (parts by weight) | — | — | — | — | — |
| | | ETD (parts by weight) | 65 | 65 | — | — | — |
| | Metathesis polymerization catalyst | | 0.05 | 0.05 | — | — | — |
| | (parts by weight) | | | | | | |
| | Crosslinking agent (parts by weight) | | 1.14 | 1.14 | — | — | — |
| | Crosslinking promoter (parts by weight) | | 20 | 20 | — | — | — |
| | Chain transfer agent (parts by weight) | | 0.85 | 0.85 | — | — | — |
| | Inorganic | Inorganic filler 1 (0.5 μm) | 80 | — | — | — | — |
| | filler | (parts by weight) | | | | | |
| | | Inorganic filler 2 (1.6 μm) | — | — | — | — | — |
| | | (parts by weight) | | | | | |
| | | Inorganic filler 3 (2.7 μm) | 160 | 60 | — | — | — |
| | | (parts by weight) | | | | | |
| | | Inorganic filler 4 (1.8 μm) | 120 | 120 | — | — | — |
| | | (parts by weight) | | | | | |
| | | Total content (wt %) | 75 | 70 | — | — | — |
| | | in composition | | | | | |
| | | Component (D):component (E) | 22:78 | — | — | — | — |

TABLE 2

| | | Example | | | | | | Comparative Example | | | | |
|---|---|---|---|---|---|---|---|---|---|---|---|---|
| | | 1 | 2 | 3 | 4 | 5 | 6 | 1 | 2 | 3 | 4 | 5 |
| Evaluation | Storage modulus | Good | Good | Good | Good | Good | Good | Poor | Poor | Poor | Poor | Good |
| | Glass transition | Good | Good | Good | Good | Good | Good | Good | Good | Good | Good | Good |
| | temperature | | | | | | | | | | | |
| | tanδ | Good | Good | Good | Good | Good | Good | Poor | Poor | Poor | Poor | Good |
| | Flexural modulus | Good | Good | Good | Good | Good | Good | Poor | Poor | Poor | Poor | Good |
| | Flame retardancy | Good | Good | Good | Good | Good | Good | Fair | Poor | Poor | Fair | Poor |

### (6) Observation Using Scanning Electron Microscope (SEM)

The laminate 1 obtained in Example 1, the laminate 8 obtained in Comparative Example 2, and the laminate 9 obtained in Comparative Example 3 were cut along the weft of the glass cloth, and the cross section thereof was wet-ground using sandpaper #3000 to obtain an observation sample. The sample was observed using a scanning electron microscope (“S-3400N” manufactured by Hitachi High-Technologies Corporation) at a magnification of 6000. An area in which the warp of the glass cloth was present was observed to determine the state of the inner-layer part of the crosslinked resin formed article forming the laminate, and an area in which the glass cloth was not present was observed to determine the state of the outer-layer part of the crosslinked resin formed article forming the laminate.

The resulting photograph was subjected to a binarization process using a digital microscope (“VHX-500” manufactured by Keyence Corporation) to calculate the ratio of the resin part.

FIG. 2 shows the resulting SEM images. FIG. 2 shows the SEM image of the laminate 8 obtained in Comparative Example 2 (See (A)), the SEM images of the laminate 9 obtained in Comparative Example 3 (See (B)), and the SEM images of the laminate 1 obtained in Example 1 (See C)).

(7) Energy-dispersive X-ray spectrometry (SEM-EDX)

The laminate 1 obtained in Example 1 and the laminate 9 obtained in Comparative Example 3 were cut along the weft of the glass cloth, and the cross section thereof was wet-ground using sandpaper #3000 to obtain an observation sample. The cross section of the sample was analyzed using a scanning electron microscope-energy-dispersive X-ray spectrometer (manufactured by Hitachi High-Technologies Corporation) at a magnification of 1000 and an accelerating voltage of 15 kV, and element mapping (Si, Mg, and Al) was performed using the resulting intensity value data.

Note that the glass cloth used to produce the crosslinked resin formed article included silicon, a small amount of aluminum, and a small amount of magnesium.

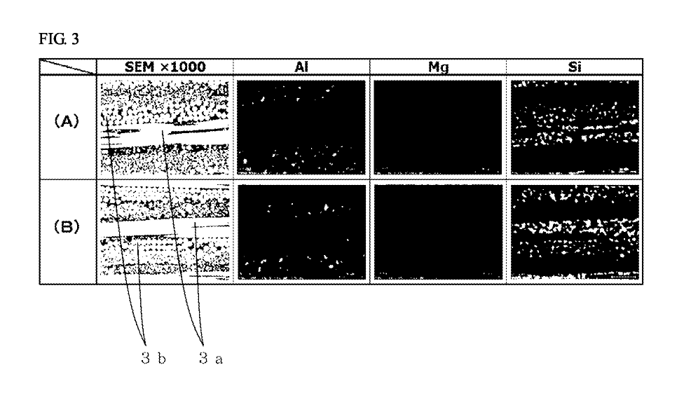

FIG. 3 shows the resulting SEM-EDX images (a color drawing thereof is submitted separately). FIG. 3 shows the SEM-EDX images of the laminate 9 obtained in Comparative Example 3 (See (A)), and the SEM-EDX images of the laminate 1 obtained in Example 1 (See (B)). In the color drawing that is submitted separately, an area in which aluminum was present as a result of element mapping is indicated in orange, an area in which magnesium was present as a result of element mapping is indicated in blue, and an area in which silicon was present as a result of element mapping is indicated in blue-green.

The following were confirmed from the results shown in Table 2, and the observation results shown in FIGS. 2 and 3.

The crosslinked resin formed articles 1 to 6 obtained in Examples 1 to 6 had a high modulus of elasticity, and exhibited excellent heat resistance and excellent flame retardancy.

The SEM images of the laminate 1 (See (C) in FIG. 2) show that both the inner-layer part and the outer-layer part were sufficiently filled with the filler.

The SEM-EDX images of the laminate 1 (See (B) in FIG. 3) show that only the inorganic filler 1 (silicon dioxide) was dispersed in the inner-layer part, and the inorganic filler 3 (aluminum hydroxide) and the inorganic filler 4 (magnesium hydroxide) were dispersed in the outer-layer part.

It is considered that both the inner-layer part and the outer-layer part of the crosslinked resin formed articles 1 to 6 were sufficiently filled with the filler, and the above results were obtained since inorganic fillers were dispersed in the inner-layer part and the outer-layer part corresponding to the average particle size.

The crosslinked resin formed articles 7 and 8 of Comparative Examples 1 and 2 were obtained by applying die polymerizable composition for forming the inner-layer part and the polymerizable composition for forming the outer-layer part in a stepwise manner.

The crosslinked resin formed articles 7 and 8 obtained by this method had a low modulus of elasticity, and exhibited poor flame retardancy.

The SEM images of the laminate 8 (see (A) in FIG. 2) show the outer-layer part of the laminate 8 was not sufficiently filled with the filler. It is considered that the crosslinked resin formed articles 7 and 8 showed the above results since the outer-layer part was not sufficiently filled with the filler, and included a large amount of resin component.

The crosslinked resin formed articles 9 to 11 of Comparative Examples 3 to 5 were obtained using one type of polymerizable composition in the same manner as the crosslinked resin formed articles 1 to 6 of Examples 1 to 6. However, the polymerizable compositions 9 and 10 used in Comparative Examples 3 and 4 did not include the component (D), and the polymerizable composition 11 used in Comparative Example 5 had a low inorganic filler content.

As a result, the crosslinked resin formed articles 9 and 10 had a low modulus of elasticity, and exhibited poor flame retardancy, and the crosslinked resin formed article 11 exhibited poor flame retardancy.

The SEM images of the laminate 9 (see (B) in FIG. 2) stow that the inner-layer part of the laminate 9 included only a small amount of filler. It is considered that the crosslinked resin formed articles 9 and 10 showed the above results since the inner-layer part was not sufficiently filled with the filler.

It is considered that the crosslinked resin formed article 11 showed the above results since the entire crosslinked resin formed article 11 was not sufficiently filled with the filler as compared with the crosslinked resin formed articles 1 to 6.

### REFERENCE SIGNS LIST

1 Inner-layer part
2a Outer-layer part I
2b Outer-layer part II
3a Inorganic fibers (weft)
3b Inorganic fibers (warp)
4 Components (e.g., crosslinkable resin and inorganic filler) derived from polymerizable composition
10 Crosslinkable resin formed article

1. A crosslinkable resin formed article that is obtained by impregnating an inorganic fibrous support with a polymerizable composition, and subjecting the polymerizable composition to bulk polymerization,
the polymerizable composition comprising (A) a cycloolefin monomer, (B) a metathesis polymerization catalyst, (C) a crosslinking agent, (D) an inorganic filler that consists of particles having an average particle size of 0.1 to 1.0 μm, and (E) an inorganic filler that consists of particles having an average particle size of 1.5 to 5.0 μm, the polymerizable composition having a total content of the component (D) and the component (E) of 60 to 80 wt %, and having a weight ratio (component (D):component (E)) of the component (D) to the component (E) of 5:95 to 40:60.

2. The crosslinkable resin formed article according to claim 1, the crosslinkable resin formed article comprising an inner-layer part that includes the inorganic fibrous support, and an outer-layer part that is adjacent to the inner-layer part, and does not include the inorganic fibrous support, wherein only the component (D) is dispersed in the inner-layer part.

3. The crosslinkable resin formed article according to claim 1, wherein the polymerizable composition comprises a cycloolefin monomer represented by a formula (I) and a crosslinkable cycloolefin monomer (that excludes the compound represented by the formula (I)) as the component (A), 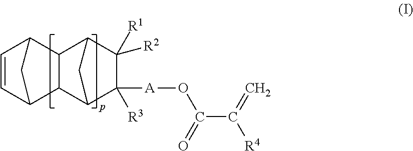
wherein R¹, R², and R³ are independently a hydrogen atom or a hydrocarbon group having 1 to 20 carbon atoms, R⁴ is a hydrogen atom or a methyl group, A is a single bond, an alkylene group having 1 to 20 carbon atoms, or a divalent group represented by a formula (II), and p is 0, 1, or 2,
*—C(═O)—O-A¹- (II)
wherein A¹ is an alkylene group having 1 to 19 carbon atoms, and * is a bonding site bonded to the carbon atom that forms the alicyclic structure in the formula (I).

4. The crosslinkable resin formed article according to claim 1, wherein the component (D) is silicon dioxide, and the component (E) is a metal hydroxide.

5. The crosslinkable resin formed article according to claim 1, the crosslinkable resin formed article producing a crosslinked resin formed article having a storage modulus at 260° C of 1.0×10⁹ Pa or more when subjected to a crosslinking reaction.

6. A crosslinked resin formed article obtained by crosslinking the crosslinkable resin formed article according to claim 1.

7. A laminate produced by stacking the crosslinkable resin formed articles according to claim 1.

8. A laminate produced by stacking the crosslinked resin formed articles according to claim 6.
